(19) United States
(12) Patent Application Publication
(10) Pub. No.: US 2023/0177633 A1
(43) Pub. Date: Jun. 8, 2023

(54) METHOD TO INFORMATIONIZE THE DEVELOPMENT OF AUTISTIC CHILDREN AND PREDICT THEIR FUTURE CAREER

(71) Applicant: EAST CHINA NORMAL UNIVERSITY, Shanghai (CN)

(72) Inventors: DONGFAN CHEN, Shanghai (CN); ZIYAN WANG, Shanghai (CN); SHENGDI CHEN, Shanghai (CN)

(21) Appl. No.: 18/157,066

(22) Filed: Jan. 19, 2023

(51) Int. Cl. G06Q 50/20; G06N 5/022

(52) U.S. Cl. CPC G06Q 50/2057; G06N 5/022

(57) ABSTRACT

A method to informationize the development of autistic children and predicting their future careers, comprising: collecting the assessment data C and occupational fitness value s of autistic children required by the occupational prediction model; constructing an occupational prediction model, assessment data C and occupational fitness value s are used to train the occupational prediction model, collecting the evaluation data C of the children to be predicted, and use the occupational prediction model to evaluate the occupational fitness value s of the children to be predicted, to obtain the suitable occupation for the children to be predicted. The present invention also discloses a system for implementing the above method. The invention also discloses a method and system for realizing the assessment of the effectiveness of a rehabilitation course and the recommendation of a course for a child with autism based on the above developmental course informatization and occupation prediction method.

### TECHNICAL FIELD

The present disclosure relates to a method for career prediction, more particularly to a method to informationize the development of autistic children and predicting their future careers.

### RELATED ART

Autism Spectrum Disorder (ASD) is a widespread neurodevelopmental disease. The core features of ASD include impairments in social communication, repetitive behaviors and restricted interests. Autism spectrum disorder affects more than 1% of the population and most of them lack the ability to take care of themselves. The employment rate is extremely low after adulthood, and they need long-term and professional care, which creates a certain economic burden for the family and society. However, at present, there is no detailed cause and early prevention strategy for the onset of autism and early rehabilitation training is the most effective method for families with autism.

In addition, the employment rate of people with autism is always low. In the United States, 25%-55% of adults with autism participate in an type of paid work and have difficulties maintaining their jobs. The employment rate of adults with autism spectrum disorders in China is less than 10%, and their workings hours and remuneration are lower than those of other disabled groups. Therefore, vocational rehabilitation training for autistic children is particularly important. (There is an urgent need for a method to predict the appropriate career type for autistic, children in the future, to have a targeted career direction, carry out vocational training before adulthood, and provide corresponding positions for internship experience after adulthood.)

### SUMMARY

In view of this, the present invention provides a method to informationize the development of autistic children and predicting their future careers, comprising:

Step a: collecting the assessment data C and occupational fitness value s of autistic children required by the occupational prediction model;

Step b: constructing an occupational prediction model, assessment data C and occupational fitness value s collected from Step a are used to train the occupational prediction model for obtaining a completed model for occupational prediction.

Step c: collecting the evaluation data C of the children to be predicted, and use the occupational prediction model trained in step b to evaluate the occupational fitness value s of the children to be predicted, to obtain the suitable occupation for the children to be predicted.

The assessment data C is obtained through the assessment comprising a background constant value C^{c} and an autistic children's ability measurement value C^{v};

the background constant value C^{c} comprises developmental information and autism diagnosis information;

the autistic children's ability measurement value C^{v} comprises assessment scores, of consonant articulation, social interaction, and executive, function brief2 scale scores for children with autism;

the occupational fitness value s is obtained through the evaluation of children who have corresponding suitable occupational positions.

The background constant value C^{c} of autistic children comprises developmental information and autism diagnosis information, represents the information related to children's initial ability and education and rehabilitation environment;

the developmental information comprises basic information about the child and the educational rehabilitation history of autistic children;

the autism diagnosis information is specifically expressed by selecting existing scores of commonly used scales for autism, which includes the scores of the autism screening scale score, autism diagnosis scale score, and other psychological assessment scale scores;

the autism screening scale is a modified infant autism scale M-CHAT (16-30 months);

the autism diagnosis scales comprise Children Autism Rating Scale CARS, Autism Behavior Scale ABC, Autism Diagnosis Observation Scale ADOS-2;

the other psychological assessment scales comprise Wechsler Intelligence Scale, Psychological Education Assessment Scale PEP-3, Picture Vocabulary Test (Chinese version) PPVT-R, Language Behavior Milestone Assessment and Placement Plan VB-MAPP Obstacle Assessment;

the autistic children's ability measurement value C^{v} can indicate the specific ability level of autistic children m speech articulation, social ability and executive function fields, and the authoritative scale score in the field is selected for measurement;

the autistic children's ability measurement value C^{v} comprises consonant articulation assessment scores, social interaction assessment scores, and executive function brief2 scale scores.

The basic information about the child comprises the child's name, gender, date of birth, age of diagnosis, concurrent diseases, family income, main caregivers, and education of the caregivers;

the educational rehabilitation process of autistic children refers to the age of rehabilitation, the number of rehabilitation process changes, satisfaction with rehabilitation effect, rehabilitation frequency, annual rehabilitation expenditure, and types of rehabilitation courses before and after enrollment in the group;

the assessment information of the consonant articulation of autistic children comprises the assessment results of bilabial/labiodental, dentolabial, alveolar/alveolopalatal, postalveolar/retroflex, velar, the four tones;

the social interaction assessment information is assessed using the “Children's Social Positioning Map”;

the executive function brief2 scale selects five categories that are confirmed to be effective for autistic children by clinical tests as evaluation indicators, namely: starting ability, planning and organization ability, conversion ability, working memory ability, and self-monitoring ability.

The occupational fitness value s refers to the fitness of autistic children for a certain occupation, which is evaluated by autistic children who have obtained corresponding occupational positions;

the assessment tool is an original occupational category assessment form for autistic patients, including an assessment category and a questionnaire;

the occupational category assessment form has a total score of240 points, of which the assessment category contains cognitive development, movement, perceptual characteristics and social development with a total score of 180 points; the questionnaire of the occupational category assessment form contains movement, perceptual characteristics and social development with a total score of 60 points.

The assessment data C as described in Step b is defined as:

C=[C^{c} C^{d} C^{a} C^{s} C^{f}]^{T}

∈ [symbol] ^{S+20}≡ [symbol] ^{≅}

wherein C^{c} represents an autistic individual's essential information, C^{d} represents autistic diagnostic information, C^{a} represents autistic consonants articulation C^{s} represents autistic social communication skills, and C^{f} represents functional execution on the brief2 scale, the super-script [−]T denotes the matrix/vector transpose;

wherein the background constant values C^{c}=C^{e}+C^{d}; the autistic children's ability measurement value C^{v}=C^{a}+C²+C^{f}.

The method according to claim 2, wherein in step b, the occupational prediction model uses a linear regression model,

techniques from machine-learning with the linear regression model are utilized to associate the assessment data C and the occupational fitness value s;

the loss-function of the linear regression model is calculated as the sum of the square 2-norm of prediction-errors on the i individual data-pairs (xᵢ, yᵢ)

$$\begin{matrix}\text{?} := {\sum }_{i} \text{?} \\ {\sum }_{i} \text{?}\end{matrix} .$$

$$\text{?} \text{indicates text missing or illegible when filed}$$

A system for informationizing the development of autistic children and predicting their future careers, comprising: a data input module, a database module, a machine learning module, a prediction module, and an output module; wherein,

the data input module is used for entering the developmental information and the diagnosis information of autistic children, the assessment score of the consonant articulation of autistic children, the social interaction assessment score, and the executive function brief2 scale score;

the database module is used for storing and screening the input developmental information and diagnosis information of autistic children, as well as the assessment scores of autistic children's consonant articulation, social interaction and executive function brief2 scale scores;

the machine learning module is used for learning and establishing the occupational prediction model of autistic children using the machine learning algorithm library in Python, and obtaining the weight value of various autistic children's characteristics in this model for the future occupation of autistic children;

the prediction module is used for substituting the basic information of autistic children, diagnosis result in information, evaluation information of consonant articulation of autistic children, social communication orientation map, and executive function brief2 scale score into the established and calculated model for prediction;

the output module is used to output the suitable occupation for autistic children in the future.

A method for assessing the effectiveness of a rehabilitation program for autistic children and recommending the program, comprising:

Step I: obtaining the test results k1 and k2 of autistic children before and after each class;

Step II: calculating the difference between the test results of each autistic child's before and after each class, the progress value Δ=k2−k1;

Step III: whenever new participants participate in a course j at the time tₖ, the n tuber of the new participants is i, the number of whole participants who have participated in the course is updated

[symbol]

is calculated as the sum of the number of new participants i and the old participants nₜ_{ₖ}^{j} who have participated in the course j, [symbol] ;

Step IV: the historical average progress value Δ̅ₗ̅_̅{̅ₖ̅}̅^̅{̅j̅}̅ of the course before the new participants participated in the course is weighted with the progress value Δₗ_{ₖ}^{j3}, Δₗ_{ₖ}^{j2}, . . . , Δₗ_{ₖ}^{j,} of the total i new participants participating in the course j obtained in Step II; the weight of the historical average progress value is the number of students nₜ_{ₖ}^{j}, who participated in the course previously, and the weight of the progress value of each new participant is 1;

Step V: according to the progress value obtained in step IV, evaluating and ranking the contribution value of the course to different indicators in social function;

Step VI: according to the ranking of different indicators corresponding to different courses, recommending courses suitable for children.

The beneficial effects of the invention include: 1. Understand all the relevant data of autistic children in their growth process, conduct a complete evaluation of the ability of autistic children, and help parents, rehabilitation teachers, etc. to master the progress of children. 2. Establish a set of career prediction methods for autistic children, calculate the suitability for each occupation through the growth and evaluation data of young autistic children, help them understand their potential, and timely take intervention and learn vocational skills to provide possibilities for future employment.

The change of progress value can show 1. Children's learning efficiency and learning progress, can help the progress of course selection. 2. The contribution value of the existing curriculum, because a class may not only help children in one aspect, but also determine whether the key and difficult points of the class are consistent with the original intention of the curriculum design through the different progress values of multiple children, and make timely changes. At the same time, it can also establish artificial intelligence algorithms based on all previous data and quantitative indicators of this course, so as to accurately push the required courses for children. 3. This set of assessments can be used to quantify the value of existing traditional rehabilitation courses and assessments, so that rehabilitation practitioners and rehabilitation teachers can better understand how to design a course and grasp the goals and priorities.

### BRIEF DESCRIPTION OF THE DRAWINGS

FIG. 1 shows a diagram of how the occupational prediction model is processed.

FIG. 2 shows a flow chart of occupational prediction.

FIG. 3 shows a diagram of the occupational goal prediction model.

FIG. 4 shows the mapping of social skills positioning of a special child in the present invention.

FIG. 5 shows an excerpt of three level-one scores measured respectively for three assessment fields.

FIG. 6 shows a sample individual's l₀-scoring chart.

FIG. 7 shows after averaging the progress value, the curriculum can be evaluated in reverse, and the contribution value of this class to different indicators of social function can be obtained.

FIG. 8 shows the courses sorted according to the value of the average progress value, or the functional attributes of a chins can be sorted according to the contribution value.

FIG. 9 shows the contribution values of different courses in various functional indicators.

### DETAILED DESCRIPTION

For autistic patients, employment is a major challenge, the biggest difficulty of which is that the suitability of autistic patients for various occupations is unknown, and they cannot be recommended suitable positions to play to their strengths. This method enables digital transformation and upgrading of education and rehabilitation with machine learning technology, and creatively classifies and summarizes various data in the process of rehabilitation education for autistic children. The various types of data are systematically classified and summarized, distinguishing three major categories: growth information (background constant value C^{c}), assessment results (ability measure C^{v}), and course performance, which can be obtained through direct measurements. However, the corresponding suitability of autistic children for each occupation is difficult to know through direct measurement, so machine learning technology will be used to algorithmically calculate the collected data and build a future occupation prediction model for autistic children, so as to predict the types of future suitable occupations for autistic children through the preliminary. At the same time, a large rehabilitation database was built to collect the data of multiple autistic children and establish a complete curriculum database and evaluation system through algorithms.

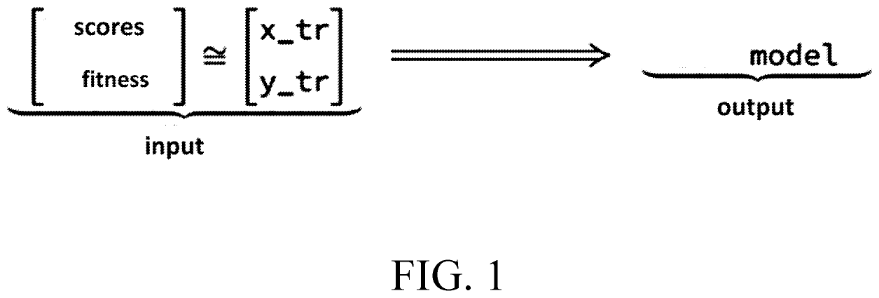

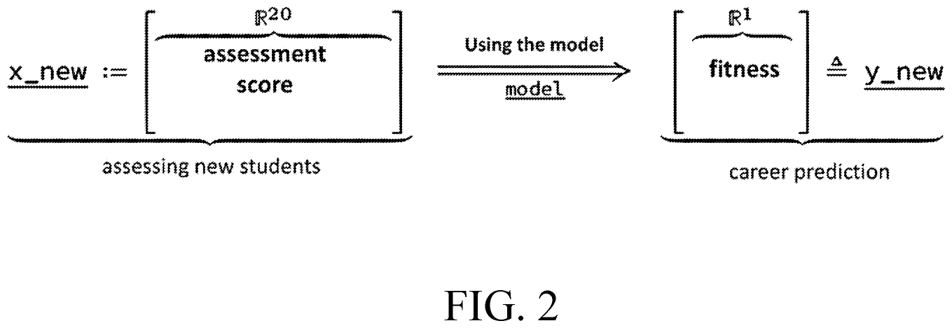

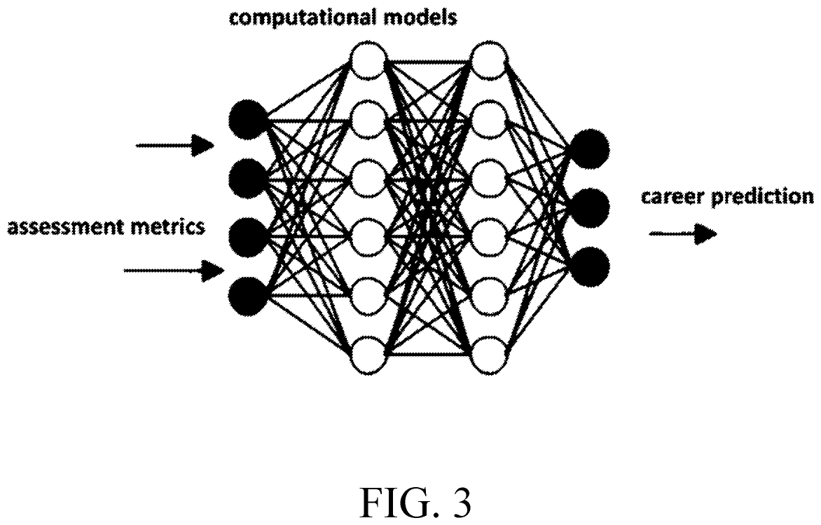

The invention provides an information based development process and career prediction method for autistic children, comprising: collecting assessment data C and output data s of autistic children required by the model; building a career prediction model, collecting the evaluation data C and career fitness value s of about 100 autistic children, train the career prediction model as shown in FIG. 1, and obtain the model of training completion; Collect the evaluation data C of the children to be predicted, and use the completed training model to evaluate the occupational fitness value s of the children to be predicted, so as to obtain the suitable occupation for the children to be predicted as shown in FIG. 2 and FIG. 3. The invention also discloses a system for realizing the above method and a method and system for evaluating wind recommending the effect of the rehabilitation course for autistic children.

The evaluation data C shall be obtained through evaluation. The background constant value C^{c} of autistic children was collected, including the development information and diagnosis information of autistic children; Children's ability measurement value C^{v}, including autistic children's consonant articulation assessment score, social interaction assessment score, and executive function brief2 scale score. The occupational fitness value s is obtained through the evaluation of children who have corresponding suitable occupational positions.

The evaluation data C and occupational fitness value s required for training the occupational prediction model have been obtained. The data collected are about 100 existing autistic children. The data collected are the evaluation data C of each child and the occupational fitness values of each child for a certain occupation. The 100 existing children mentioned above have received comprehensive rehabilitation intervention and years of tracking results, and have obtained relevant data. These collected data can be used to start training the model, that is, iteratively optimizing the model parameter w.

In the method, the background constant value C^{c} is calculated using the cumulative integration rule.

The occupational prediction model trained as used to predict the occupational fitness of newly added autistic children. During the process, it is necessary to obtain the evaluation data C of newly added autistic children, and then calculate the output occupational fitness Ŝ through the model, the spike superscript \hat{ } is used to express the predicted value of the model, not the actual collected data.

The background constant value C^{c} of autistic children can show that the indicators corresponding to this value basically do not change greatly during the growth of children, and it represents the information related to children's initial ability and education and rehabilitation environment; It includes the development information of autistic children and the diagnosis information of autism. Said developmental information includes basic information about the child and the educational rehabilitation history of the child with autism; said autism diagnosis information is specifically expressed by selecting existing scores of commonly used scales for autism, where the scales are selected with reference to the book “Autism Spectrum Disorders—Frontiers in Medicine and Research Advances”. The scale is internationally certified and has high reliability and validity, in this project, the scores of children who have been assessed by professional scales in hospitals or relevant institutions are collected as the scoring basis, including the scores of the autism screening scale Autism diagnosis scale score, and other psychological assessment scale score; The screening scale is a modified infant autism scale M-CHAT (16-30 months); The autism diagnosis scale includes Children Autism Rating Scale CARS, Autism Behavior Scale ABC, Autism Diagnosis Observation Scale ADOS-2; The other psychological assessment scales mentioned include Wechsler Intelligence Scale, Psychological Education Assessment Scale PEP-3, Picture Vocabulary Test (Chinese version) PPVT-R, Language Behavior Milestone Assessment and Placement Plan VB-MAPP Obstacle Assessment.

The basic information about the child includes the child's name, gender, date of birth, age of diagnosis, concurrent diseases, family income, main caregivers, and education of the caregivers; The education and rehabilitation process of autistic children refers to the age of rehabilitation, the number of rehabilitation process changes, satisfaction with rehabilitation effect, rehabilitation frequency, annual rehabilitation expenditure, and types of rehabilitation courses before and after enrollment in the group;

the autistic children's ability measurement value C^{v} can indicate the specific ability level of autistic children in speech articulation, social ability and executive function fields, and the authoritative scale score in the field is selected for measurement; Including the assessment scores of consonant articulation, social interaction assessment scores, and executive function brief2 scale scores. The assessment information of the consonant articulation of autistic children includes the assessment results of Bilabial/labiodental, dentolabial, alveolar/alveolopalatal, postalveolar/retroflex, velar, the four tones; The social interaction assessment information is assessed using the “Children's Social Positioning Map”. The map chooses the Autism Social Communication Assessment Form of the China Disabled Persons' Federation as the main reference for the evaluation orientation and training system, because: (1) the assessment form contains 47 assessment items, which can basically reflect the social development level of autistic children; (2) The evaluation project can be directly used to formulate education and training plans; (3) It is widely applicable to children of preschool age (0-6 years old). to line with the principle of early screening and early intervention; (4) At present, it is most widely used in China, and has been tried for ten years. It is used in special schools and public rehabilitation institutions across the country, and is familiar to front-line rehabilitation therapists and teachers. They are based on cognitive psychology, linguistics, sociology, child development psychology, and the theory of psychological development of special children; Based on 47 assessment items in the field of social interaction for children aged 0-72 months; From easy to difficult, it is divided into eight thematic categories: social attention, self-consciousness, non-verbal social skills, oral social skills, greetings, farewell, telephone etiquette, and high-level etiquette.

The Archimedes spiral curve is used in the present invention to connect the 47 assessment points sequentially in order from easy to difficult to form a trajectory of children's social competence development, and a radar chart consisting of a reference month age and a social section is established, with each vertex on the grid representing an assessment item point containing 47 assessment items. It can be seen that the degree of the assessment point closest to the center of the circle is the easiest, and the difficulty gradually increases from inside to outside, which is the developmental trajectory of children's social skills.

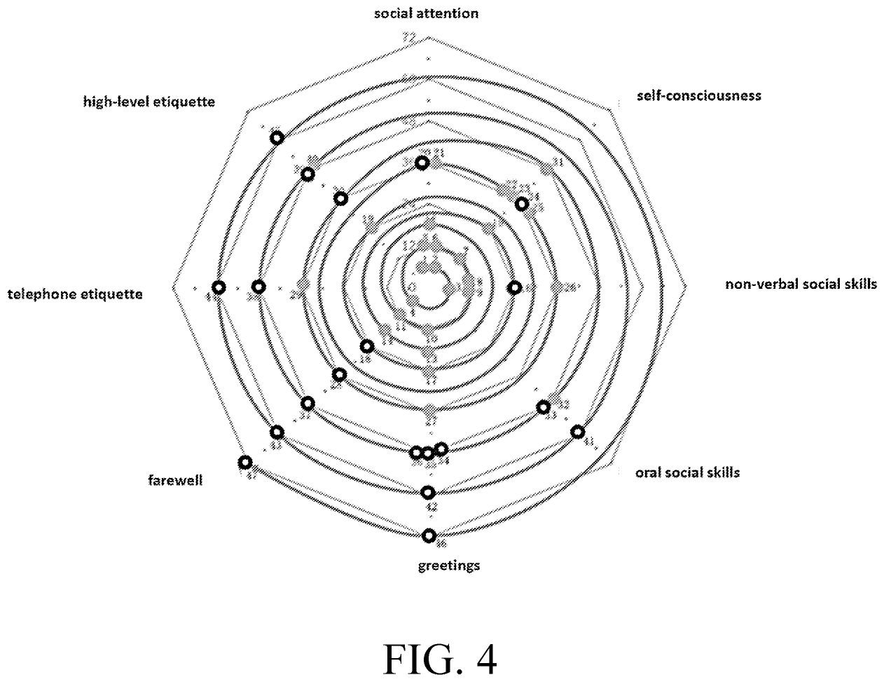

As shown in FIG. 4, an autistic child's social competence locus mapping is illustrated, the set of failed and passed assessment points are represented by ◯and●. The following information can be obtained (1) the reference age and socialization section in which any of the 47 items were assessed, and (2) the position of any of the 47 items assessed in the overall developmental status of social skills, in relation to the other items. (3) The current development of children's social skills in each month's age group and each social area; (4) Marking the items that are not passed, we can directly obtain the breakpoint of children's social skills development. This can show the development trend of children's social interaction ability and pinpoint the development level of children at this stage. According to Vygotsky's “nearest developmental zone” theory, the most suitable items for immediate intervention should be those that children have not yet acquired but are most likely to acquire after the intervention, i.e., the least difficult of the un-acquired items. According to FIG. 4, the difficulty of the items is assessed from the center of the circle, and the 47 assessment points are arranged from inside to outside along the Archimedean spiral curve, in order from easy to difficult, so that the item closest to the center of the circle, ◯, is the item most in need of training, and the training and development trend of children's social skills can be planned by progressively searching for◯along the Archimedean spiral curve.

The executive function scale is the second version of the Executive Rating Inventory of Executive Function (BRIEF-2), which is used to evaluate the executive function of adults, adolescents and preschool children, and to evaluate the views of adolescents on their cognitive, emotional and behavioral functions and their self-regulation ability. It was developed by Dr. Gerard A. Gioia, etc. The executive function brief2 scale selects five categories that are confirmed to be effective for autistic children by clinical tests as evaluation indicators, namely: initiation, planning and organizing, switching, working, memory, and self-monitoring ability.

The priming ability reflects the ability of children to start a task or activity and independently generate ideas, responses or problem-solving strategies;

The plan organization ability is used to measure the child's ability to cope with current and future task needs;

The transfer ability reflects the ability of children to freely transfer from one aspect of one situation, activity or problem to another according to the needs of the situation;

The working memory ability reflects the ability of children to remember information in order to complete tasks, including encoding information, generating goals, planning and sequential steps to achieve goals;

The self monitoring ability reflects the children's or adolescents' understanding of the impact of their behaviors on others and their ability to compare with behavior standards or expectations.

Table 1 and Table 2 respectively describe the specific measurement items of the above C^{c} and C^{v}.

TABLE 1

| developmental information | autism diagnosis information |
|---|---|
| (2 items) C^{e} | (3 items) C^{d} |
| Basic Information | screening scale |
| education and | diagnosis scale |
| rehabilitation process | other psychological |
| | assessment scales |

TABLE 2

| consonant articulation | Social ability | executive function |
|---|---|---|
| (7 items) C^{a} | (8 items) C^{s} | (5 items) C^{f} |
| Bilabial/labiodental | social attention | initiation |
| dentolabial | self-consciousness | planning and organizing |
| alveolar/alveolopalatal | non-verbal social | switching |
| | skills | |
| postalveolar/retroflex | oral social skills | working memory |
| alveolar | greetings | self-monitoring ability |
| velar | farewell | |
| the four tones | telephone etiquette | |
| | and high-level | |
| | etiquette | |

Among them, occupational fitness values refers to the fitness of autistic children for a certain occupation, which is evaluated by autistic children who have obtained corresponding occupational positions. The assessment tool is the original occupational category assessment form for autistic patients, including assessment and questionnaire;

There are 60 questions in the evaluation part and questionnaire part of the occupational category evaluation form, including children's abilities in cognitive development, movement, perceptual characteristics and social development, with a total score of 240 points;

The evaluation category can reflect the specific level of children's grip, memory, computing ability, color recognition and other aspects required by the occupation, and can be scored through on-site evaluation questions; The evaluation category can reflect the sense of sensitivity, interests, personal expertise and other aspects required by children in their careers. Because some test questions are difficult to show in the on-site evaluation task or easily cause children's sensitivity, they choose to supplement the evaluation category in the form of parent questionnaires in the four aspects of abilities.

The following shows some of the questions and test methods in the assessment section:
Task A: Self-introduction.
Required materials: None
Guidance: Please introduce yourself first.
Implementation: Sit face-to-face and reach out to the child with the palm of your hand and say the instructional words. If the child does not respond, change the questioning style: “What is your name?” “How old are you?” “What do you like to do?”
Time: 30 s
Topic No. 1: Dialogue
Functional area: Social development
Examining ability: verbal communication
Adapted to the position: general
Scoring rules.
Score of 4: Ability to initiate the conversation associated with today's assessment, ask questions or initiate communication (this question is re-scored at the end of the test, and only the ability to initiate other conversations will score 5)
3 points: able to introduce yourself in more than 3 aspects (e.g., name, age, gender, school are all “aspects”)
2 points; able to introduce yourself from 1-3 aspects
1 point: unable to complete self-introduction, but can answer teacher's questions
0 points: can neither introduce themselves nor respond to teacher questions
Question No. 2: Language comprehension and expression
Functional area: Social development
Examining ability: verbal communication
Adapted to the position: general
Scoring rules.
4 points: introduce yourself with correct grammar and usage, no word order reversal, fluent expression
3 points: Occasional reversal and repetition in self-presentation, but able to correct and continue on his own
2 points: able to understand the teacher's questions and respond to the content of the teacher's questions
1 point: whether self-expression or answering questions in the process of confusion, making it difficult to understand the content
0 points: no vocalization throughout the assessment

The following shows some of the questions in the questionnaires assessment section:
Functional area: Social development
Question No. 46: Whether you can attend class or complete your homework on time
Examining competencies: self-planning and time perspective
Adapted to the position: general
4 points: always completed within the time limit and without guidance
3 points: often can be completed within the specified time but occasionally need to be reminded to supervise
2 points: always need to be urged and reminded to finish on time
1 point: always late or postpone homework even when urged and reminded
0 points: never finish on time
Question No. 47: Ability to continuously learn new things
Examining ability: ability to learn, receptiveness to change
Adapted to the position: leather sculpture, music, pets
4 points: very like to learn new things
3 points: more like to learn new things
2 points: not active but also not exclusive
1 point: do not like to learn new things
0 points: very resistant
Topic No. 48: Emotional behavior
Examining ability: the ability to control one's emotions, such as the ability not to lose one's temper and not to shout
Adapted to the position: general
4 points: always able to control their emotions
3 points: often able to control their emotions, but occasionally need to be reminded, rarely lose their temper
2 points: frequent tantrums, but parents or parents can control
1 point: always have emotional behavior problems and difficult to control
0 points: completely unable to control emotions

The background constant value C^{c} is calculated using the cumulative integration rule, the original score will be standardized and the data are calculated with equal weight. The lower the final score is, the rehabilitation environment needs to be changed to be conducive to children's rehabilitation development.

In the invention, the ability measurement value C^{v} is calculated using a tree data structure. The tree data structure refers to that when calculating the ability measurement value of children, three categories of abilities (speech articulation, social ability, and executive function) need to be layered. Each layer has its evaluation indicators, and the bottom indicators (such as speech articulation, social ability, and executive function indicators) are the most general, the higher the level, the more specific and accurate it can be measured. It is like a tree-like hierarchical structure, so it is named a tree like data structure.

The assessment data C as described in Step b is defined as:

\vec{C}:=[C^{e} C^{d} C^{a} C^{s} C^{f}]^{T}

wherein C^{c} represents an autistic individuals essential information, C^{d} represents autistic diagnostic information, C^{a} represents autistic consonants articulation C^{s} represents autistic social communication skills, and C^{f} represents functional execution on the brief2 scale, the super-script [−]^{T} denotes the matrix/vector transpose;

Where constant background values C^{c}=C^{c}+C^{d}; Varying evaluation values C^{v}=C^{a}+C^{s}+C^{f}.

These five elements further constitute the previously mentioned (constant) background-value C^{c} and the (varying) evaluation-value C^{v}. In particular, the background-value C^{c} is defined as

C^{c}:=[C^{e} C^{d}]^{T} ∈ [symbol] ²⁺³≡ [symbol] ⁵

while the evaluation-value C^{v} is understood as

C^{c}:=[C^{a} C^{s} C^{f}]^{T} ∈ [symbol] ⁷⁺⁸⁺⁵≡ [symbol] ²⁰

Note that, to unclutter notations, the habitual overhung arrow \vec{. . .} to signal vectors is disposed of. As the formulae above demonstrate, the dimensions of the background-value C^{c} and the evaluation-value C^{v} are computed as the sum of their respective concatenating components. As an example, the dimension of the background-value C^{c} (5) is found with the addition of the dimension of its constituents C^{e} (2) and C^{d} (3).

Thus follows the dimension as well as the domain of the assessment data C as a whole:

C:=[C^{c} C^{d} C^{a} C^{s} C^{f}]^{T}

∈ [symbol] ⁵⁺²⁰≡ [symbol] ²⁵

Techniques from machine-learning with the linear-regression model are utilized to associate the evaluation-values C^{v} and the occupation-suitability values s.

The loss-function of the regression-model is calculated as the sum of the square (2) norm of prediction-errors on the i individual data-pairs (xᵢ,yᵢ)

$$\begin{matrix}{L}^{lin - regr} := {\sum }_{i} \{ {l}_{i}^{lin - regr} \} \\ {\sum }_{i} \{ {( {y}_{i} - w ∘ {x}_{i} )}^{2} \}\end{matrix}$$

In particular, the regression model, once calculated with the training-procedure outlined in later sections, predicts the occupation-suitability values ŝ for individuals, of which only the evaluation-values C^{v} are available. Concretely, the dot-product of the internal regression-model weight w and the evaluation-values C^{v} are calculated.

Given the dimensionality of the to-be-obtained weights of the linear-model, a sample size of approximately one hundred autistic individuals is required to complete the training-step before theoretical reasonable predictions are deliverable.

A system to informationize the development of autistic children and predicting their future careers, comprising: a data input module, a database module, a machine learning module, a prediction module, and an output module; wherein,

the data input module is used for entering the developmental information and the diagnosis information of autistic children, the assessment score of the consonant articulation of autistic children, the social interaction assessment score, and the executive function brief2 scale score;

the database module is used for storing and screening the input developmental information and diagnosis information of autistic children, as well as the assessment scores of autistic children's consonant articulation, social interaction and executive function brief2 scale scores;

the machine learning module is used for learning and establishing the occupational prediction model of autistic children using the machine learning algorithm library in Python, and obtaining the weight value of various autistic children's characteristics in this model for the future occupation of autistic children;

the prediction module is used for substituting the basic information of autistic children, diagnosis result information, evaluation information of consonant articulation of autistic children, social communication orientation map, and executive function brief2 scale score into the established and calculated model for prediction;

the output module is used to output the suitable occupation for autistic children in the future.

The invention also provides a method for evaluating and recommending the effect of the rehabilitation course on autistic children. The underlying logic of the course evaluation and the function evaluation is consistent, but the expression is different. That is, the same tree data structure and bottom-up iteration method are adopted. However, by selecting different test materials, the invention can name this test method the quick test method. The results of the quick test method before or after class show whether children have improved their speech articulation, social ability and executive function after this lesson. Quick test K1 refers to the score of the pre-class test, and K2 refers to the score of the post-class test. The contents of the pre and post-test are shown in Table 3 and Table 4.

TABLE 3

| Functional | Assessment | Pre-test | Post-test |
|---|---|---|---|
| area L₀ | indicators L₁ | content L₂ | content L₂ |
| Social ability | Greetings | Responds to teacher's | Responds to teacher's |
| | | greeting with words or | greeting with words or |
| | | gestures | gestures |
| | farewell | Saying goodbye to the | Responding to the teacher's |
| | | teacher with words or | goodbye with words or |
| | | gestures | gestures |
| | Social attention | Ability to pay attention | Ability to pay attention |
| | | to people or events | to people or events |
| | | around you | around you |
| | self-consciousness | Hearing a response | Hearing a response |
| | | to your name | to your name |
| | Non-verbal social | Use appropriate actions | Use appropriate actions |
| | skills | to express ideas | to express ideas |
| | Oral Social | Use the right language to | Use the right language to |
| | Skills | get the point across | get the point across |
| | Telephone | Simulation of the telephone | Simulation of the telephone |
| | Etiquette | process | process |
| | High Level | One sentence that children | One sentence that children |
| | Etiquette | need in say in this lesson | need to say in this lesson |
| | | (example: Good morning | (example: Good morning |
| | | teacher) | teacher) |
| executive | initiation | Define the target | Define the target |
| function | Planning and | Develop a plan | Develop a plan |
| | organizing | | |
| | switching | Programming Conversion | Programming Conversion |
| | Working memory | Implementation Plan | Implementation Plan |
| | Self-monitoring ability | Self-evaluation | Self-evaluation |
| consonant | Bilabial/labiodental | /m//b//p//f/ | /m//b//p//f/ |
| articulation | dentolabial | /z///c//s/ | /z///c//s/ |
| | alveolar/alveolopalatal | /n//d//t//l/ | /n//d//t//l/ |
| | postalveolar/retroflex | /zh//ch//sh//r/ | /zh//ch//sh//r/ |
| | alveolar | /j//q//x/ | /j//q//x/ |
| | velar | /g//k//h/ | /g//k//h/ |
| | four tones | 1, 2, 3, 4 | 1, 2, 3, 4 |

As shown in Table 3, testing contents are divided by functional areas, including: social ability, executive function, and consonant articulation;

in social ability, assessment indicators are divided into greeting, farewell, social attention, self-consciousness, non-verbal social skills, oral social skills, telephone etiquette, high level etiquette;

the pre and post-test containing the same testing contents; the pre and post-test content of greeting indicator is responding to teacher's greeting with words or gestures, the pre and post-test content of farewell indicator is saying goodbye to the teacher with words or gestures, the pre and post-test content of social attention indicator is ability to pay attention to people or events around you, the pre and post-test content of self-consciousness is hearing a response to your name, the pre and post-test content of non-verbal social skills i using appropriate actions to express ideas, the pre and, post-test content of oral social skills is using the right language to get the point across, the pre and post-test content of telephone etiquette is simulation of the telephone process, the pre and post-test content of high level etiquette is one sentence that children need to say in this lesson (example; good morning teacher);

in executive function, assessment indicators are divided into initiation, planning and organizing, switching, working memory, self-monitoring ability;

the pre and post-test containing the same testing contents; the pre and post-test content of initiation indicator is defining the target, the pre and post-test content of planning and organizing indicator is developing a plan, the pre and post-test content of switching indicator is programming conversion, the pre and post-test content of working memory indicator is implementation plan, the pre and post-test content of self-monitoring ability indicator is self-evaluation;

in consonant articulation, assessment indicators are divided into bilabial/labiodental, dentolabial, alveolar/alveolopalatal, postalveolar/retroflex, alveolar, velar, four tones;

the pre and post-test containing the same testing contents; the pre and post-test content of bilabial/labiodental indicator is /m//b//p//f/, the pre and post-test content of dentolabial indicator is /z//c//s/, the pre and post-test content of alveolar/alveolopalatal indicator is /n//d//t//l/, the pre and post-test content of postalveolar/retroflex indicator is /zh//ch//sh//r/, the pre and post--test content of alveolar indicator is /j//q//x/, the pre and post-test content of velar indicator is /g//k//h/, the pre and post-test content of four tones indictor is 1, 2, 3, 4 tones.

TABLE 4

| Assessment indicators | Scoring Criteria | | | | |
|---|---|---|---|---|---|
| L₁ | 1 | 2 | 3 | 4 | 5 |
| Greetings | No | An error | Partially | Completed | Complete |
| | answer | occurred | correct | with | independently |
| | | | | teacher's | and correctly |
| | | | | reminder | |
| farewell | No | Completely | Willingness to | Completed | Can greet |
| | response | wrong | say hello, but | with parent | teachers |
| | from | response (e.g., | unable to say it | or teacher | voluntarily |
| | students | hitting the | correctly | prompting | |
| | | teacher) | | | |
| Social attention | No | An error | Partially | Complete | Complete |
| | answer | occurred | correct | with | independently |
| | | | | teacher's | and correctly |
| | | | | reminder | |
| self-consciousness | No | An error | Partially | Completed | Complete |
| | answer | occurred | correct | with | independently |
| | | | | teacher's | and correctly |
| | | | | reminder | |
| Non-verbal social | No | An error | Partially | Completed | Complete |
| skills | answer | occurred | correct | with | independently |
| | | | | teacher's | and correctly |
| | | | | reminder | |
| Oral Social Skills | No | An error | Partially | Complete | Complete |
| | answer | occurred | correct | with | independently |
| | | | | teacher's | and correctly |
| | | | | reminder | |
| Telephone Etiquette | No | Completely | There are more | Some | Exactly right |
| | answer | unintelligible | sounds that are | individual | |
| | | | not clear but | sounds are | |
| | | | understandable | not clear | |
| High Level Etiquette | No | Students | Wrong answer | Can | Can be |
| | output | cannot | | understand | understood |
| | for | understand or | | not express | and expressed |
| | students | express | | | |
| initiation | No | Students say | Students stated | Students | Students |
| | response | the wrong | some of the | state the | independently |
| | from | goal. | objectives | correct | state the |
| | students | | correctly. | target with | correct goal. |
| | | | | teacher | |
| | | | | prompting. | |
| Planning and | No | Students make | The plan | Students | Students |
| organizing | response | completely | developed by | develop | develop |
| | from | wrong plans. | the student was | the correct | correct plans |
| | students | | partially | plan with | independently. |
| | | | correct. | teacher | |
| | | | | prompts. | |
| switching | No | Students | The student's | Students | Students |
| | response | perform | programming | program | complete |
| | from | completely | was partially | correctly | correct |
| | students | wrong | correct. | with | programming |
| | | programming. | | teacher | independently. |
| | | | | prompts. | |
| Working memory | No | Students | The student | Students | Students |
| | response | cannot have | executed the | get Robot | independently |
| | from | Robot Goku | plan partially | Goku to | get Robot |
| | students | execute a plan | correctly | execute the | Goku to |
| | | or execute a | | correct | execute the |
| | | completely | | plan with | plan correctly. |
| | | wrong plan. | | the | |
| | | | | assistance | |
| | | | | of the | |
| | | | | teacher. | |
| Self-monitoring | No | Students make | The student's | Students | Students |
| ability | response | completely | self- | self- | independently |
| | from | wrong self- | assessment | evaluate | and correctly |
| | students | assessments | does not | correctly | self-evaluate |
| | | | exactly match | with | |
| | | | his | teacher | |
| | | | performance. | prompts. | |
| Bilabial/labiodental | No | More than 3 | There are 1-2 | Complete | Complete |
| | answer | errors | errors | correctly | independently |
| | | | | with | and correctly |
| | | | | teacher | |
| | | | | reminders | |
| dentolabial | No | More than 3 | There are 1-2 | Complete | Complete |
| | answer | errors | errors | correctly | independently |
| | | | | with | and correctly |
| | | | | teacher | |
| | | | | reminders | |
| alveolar/alveolopalatal | No | More than 3 | There are 1-2 | Complete | Complete |
| | answer | errors | errors | correctly | independently |
| | | | | with | and correctly |
| | | | | teacher | |
| | | | | reminders | |
| postalveolar/retroflex | No | More than 3 | There are 1-2 | Complete | Complete |
| | answer | errors | errors | correctly | independently |
| | | | | with | and correctly |
| | | | | teacher | |
| | | | | reminders | |
| alveolar | No | More than 3 | There are 1-2 | Complete | Complete |
| | answer | errors | errors | correctly | independently |
| | | | | with | and correctly |
| | | | | teacher | |
| | | | | reminders | |
| velar | No | More than 3 | There are 1-2 | Complete | Complete |
| | answer | errors | errors | correctly | independently |
| | | | | with | and correctly |
| | | | | teacher | |
| | | | | reminders | |
| four tones | No | More than 3 | There are 1-2 | Complete | Complete |
| | answer | errors | errors | correctly | independently |
| | | | | with | and correctly |
| | | | | teacher | |
| | | | | reminders | |

As shown in Table 4, giving scores ranging from 1 to 5 of each assessment indicators, according to the scoring criteria.

For greeting, social attention, self-consciousness, non-verbal social skills or oral social skills, no answer will be scored as 1, an error occurred will be scored as 2, partially correct will be scored as 3, complete with teacher's reminder will be scored as 4, complete independently and correctly will be scored as 5;

for farewell, no response from students will be scored as 1, completely wrong response (such as hitting the teacher) will be scored as 2, willingness to say hello but unable to say it correctly will be scored as 3, completed with parent or teacher prompting will be scored as 4, can greet teachers voluntarily will be scored as 5;

for telephone etiquette, no answer will be scored as 1, completely unintelligible will be scored as 2, more sounds that are not clear but understandable will be scored as 3, some individual sounds are not clear will be scored as 4, exactly right will be scored as 5;

for high level etiquette, no output for students will be scored as 1, students cannot understand or express will be scored as 2, wrong answer will be scored as 3, can understand not express will be scored as 4, can be understood and expressed will be scored as 5.

For initiation, no response from students will be scored as 1, students say the wrong goal will be scored as 2, students stated some of the objectives correctly will be scored as 3, students state the correct target with teacher prompting will be scored as 4, students independently state the correct goal will be scored as 5;

for planning and organizing, no response from students will be scored as 1, students make completely wrong plans will be scored as 2, the plan developed by the student was partially correct will be scored as 3, students develop the correct plan with teacher prompts will be scored as 4, students develop correct plans independently will be scored as 5;

for switching, no response from students will be scored as 1, students perform completely wrong programming will be scored as 2, the student's programming was partially correct will be scored as 3, students program correctly with teacher prompts will be scored as 4, students complete correct programming independently will be scored as 5;

for working memory, no response from students will be scored as 1, students cannot have Robot Goku execute a plan or execute a completely wrong plan will be scored as 2, the student executed the plan partially correctly will be scored as 3, students get Robot Goku to execute the correct plan with the assistance of the teacher will be scored as 4, students independently get Robot Goku to execute the plan correctly will be scored as 5;

for self-monitoring ability, no response from students will be scored as 1, students make completely wrong self-assessments will be scored as 2, the student's self-assessment does not exactly match his performance will be scored as 3, students self-evaluate correctly with teacher prompts will be scored as 4, students independently and correctly self-evaluate will be scored as 5.

For bilabial/labiodental, dentolabial, alveolar/alveolopalatal, postalveolar/retroflex, alveolar, velar, or tour tones, no answer will be scored as 1, more than 3 errors will be scored as 2, 1-2 errors will be scored as 3, complete correctly with teacher reminders will be scored as 4, complete independently and correctly will be scored as 5.

A method for assessing the effectiveness of a rehabilitation program for autistic children and recommending the program, comprising:

Step I: obtaining the test results k1 and k2 of autistic children before and after each class;

Step II: calculating the difference between the test results of each autistic child's before and after each class, the progress value Δ=k2−k1;

Step III: whenever new participants participate in a course j at the time tₖ, the number of the new participants is i, the number of whole participants who have participated in the course is updated to nₜ_{ₖ₊₁}^{j}, nₜ_{ₖ₊₁}^{j} is calculated as the sum of the number of new participants i and the old participants nₜ_{ₖ}^{j}who have participated in the course j, nₜ_{ₖ₊₁}^{j}=nₜ_{ₖ}^{j}+1;

Step IV: the historical average progress value Δ̅ₗ̅_̅{̅ₖ̅}̅^̅{̅j̅}̅ of the course before the new participants participated in the course is weighted with the progress value Δₗ_{ₖ}^{j,1}, Δₗ_{ₖ}^{j,2}, . . . , Δₗ_{ₖ}^{j,i} of the total i new participants participating in the course j obtained in Step II; the weight of the historical average progress value is the number of students nₜ_{ₖ}^{j}, who participated in the course previously, and the weight of the progress value of each new participant is 1;

Step V: according to the progress value obtained in step IV, evaluating and ranking the contribution value of the course to different indicators in social function;

Step VI: according to the ranking of different indicators corresponding to different courses, recommending courses suitable for children.

The rehabilitation effect of the program was considered as the positive effect of the program on the children with autism in all three areas of competence (speech and language, social skills, and executive functioning), as expressed by the average progress value of the students who participated in the program. This average progress is ranked, and higher scores on a skill point indicate that the program is more appropriate for the rehabilitation of that skill point.

When a new student enters the program, the assessment scores are used to identify their weaknesses, and the highest ranked of these skill points requiring intervention is recommended in order.

The invention also provides a system fair realizing the above curriculum effect evaluation and recommendation method, which comprises a data entry module, a database module, a machine learning module and a prediction module; Among them,

Data entry module: including the front-end web page and WeChat applet, which is responsible for entering the scores of two quick tests for autistic children before and after each class;

Database module: it is responsible for storing and screening the scores of two quick tests of autistic children before and after each class; The filtering is to filter the data according to the required model and model characteristics;

Machine learning module: use the iterative algorithm in cybernetics to learn and establish the effect evaluation and course recommendation model of the autistic children's rehabilitation course, so as to obtain the average progress value of the autistic children in each course;

Output module: It is responsible for recommending regular courses for children by combining the quick test score evaluation results with the calculated average progress value of each course.

The results of a total of 34 items in the development information and diagnostic information table data are represented by vector data, as shown in Tables 5-7.

As shown in Table 5 (i.e., Table 5A, 5B, and 5C) and Table 6 (i.e., Table 6A and 6B), nodes of developmental information sources for children with autism including basic information and educational rehabilitation journey;

TABLE 5A
Physiology

| Projects | Score | Scoring Rules |
|---|---|---|
| Name Gender | | Male 1. |
| | | Female 0 |
| Date of birth | | xxxx year xx month age xx months |
| Age of diagnosis | | Months of age xx months |
| Whether other diseases | | 0: No |
| are complicating (What | | 1: General diseases (such as epilepsy, |
| diseases, if any, | | gastrointestinal diseases, etc.) |
| should be added) | | 2: Mental illness (anxiety, depression, |
| | | etc.) |
| | | 3: Developmental disorders (mental |
| | | retardation, ADHD, etc.) |
| | | 4: Personality disorders (paranoid, |
| | | schizotypal) |
| | | 5: Emotional behavior problems |
| | | (aggression, self-injury, etc.) |
| Are there any allergies | | No0 |
| | | Allergy to drugs1 |
| | | Food allergy 2 |
| | | (add allergy to Ho) |
| Perceptual situation | | 0: No abnormality |
| | | 1: visual ultra/weakly sensitive |
| | | (need to mark ultra or weakly |
| | | sensitive) |
| | | 2: Auditory hypo/hypersensitivity |
| | | 3: Tactile hyper/weak sensitivity |
| | | 4: Olfactory hyper/weak sensitivity |

TABLE 5B
Environment

| Projects | Score | Scoring Rules |
|---|---|---|
| Household income | | Monthly income level for five levels |
| | | of scoring. |
| | | 0: 0-2000 RMB |
| | | 1: 2000-5000 RMB |
| | | 2: 5000-10000 RMB |
| | | 3: 10000-50000 RMB |
| | | 4: 50,000 RMB or more |
| (Second Dependent) | | Five levels of scoring education |
| Father's Highest Education | | 0: Primary and Junior High School |
| | | 1: High school or college |
| | | 2: Undergraduate |
| | | 3: Master's degree |
| | | 4: PhD and above |
| (First Dependent) | | Five levels of scoring education |
| Mother's highest education | | 0: Primary and Junior High School |
| | | 1: High school or college |
| | | 2: Undergraduate |
| | | 3: Master's degree |
| | | 4: PhD and above |
| Primary Caregiver | | 0: Parents |
| | | 1: (External) Grandparents |
| | | 2: Brothers/sisters |
| | | 3: Other relatives |
| | | 4: Other non-relatives (such as |
| | | nannies, aunts, etc.) |
| Length of time with the caregiver | | 0: Under 1 hour |
| | | 1: 1-2 hours |
| | | 2: 2-5 hours |
| | | 3: 5-8 hours |
| | | 4: 8 hours or more |
| Whether the child is enrolled in school | | 0: Not enrolled |
| | | 1: Entering a special education school |
| | | 2: Access to institutions |
| | | 3: General School Placement/Inclusion |
| | | 4: Normal attendance at general schools |

TABLE 5C
Other

| Projects | Score | Scoring Rules |
|---|---|---|
| Parental Personality | | 0: All subscale scores ranged |
| Eysenck Personality Questionnaire | | from 43.33-65.7 |
| Short Form Scale China (EPQ - RSC) | | 1: High P score |
| P mental quality scale (12 items), E | | 2: Low P score |
| extraversion (12 items), N neuroticism | | 3: High E score |
| (12 items), L masking scale (12 items), | | 4: Low E score |
| total 48 items. The scores of each | | 5: N score high |
| subscale ranged from 43.33 to 65.70 | | 6: N score low |
| for the intermediate type. | | |
| A high P score indicates indifference | | |
| and lack of compassion; a high E score | | |
| indicates extroversion and emotional | | |
| impulsiveness, while a low E score | | |
| indicates introversion, emotional | | |
| stability and a regular lifestyle; a high | | |
| N score indicates anxiety, depression | | |
| and unstable emotional response, while | | |
| a low N score indicates emotional | | |
| calmness and slow response; an L | | |
| score is used to determine the validity | | |
| or invalidity of the questionnaire, | | |
| while a high L score indicates untrue | | |
| answers and invalid questionnaire. | | |
| Self-interest | | 0: No clear interests |
| | | 1: Have 1-2 hobbies |
| | | (need to list) |
| | | 2: Have 3-5 hobbies and interests |
| | | (need to list) |
| | | 3: Have 1-2 hobbies and have a |
| | | clear career orientation |
| | | (need to list) |
| | | 4: Have 3-5 hobbies and have a |
| | | clear career orientation |
| | | (need to list) |

As shown in Tables 5A-5C, the basic information including physiology, environment and other; wherein, the physiology is divided into name gender, date of birth, age of diagnosis, whether other diseases are complicating (what diseases, if any, should be added), if there are any allergies, and perceptual situation; the environment is divided into household income, (second dependent) father's highest education, (first dependent) mother's highest education, primary caregiver, length of time with the caregiver, and whether the child is enrolled in school; the other including different questionnaires and self-interest;

in Table 5A, the scoring rule of name gender is that male is recorded as 1 and female is recorded as 0; the scoring rule of date of birth is “xxxx year xx month age xx months”, the scoring rule of age of diagnosis is “Months of age xx months”, the scoring rule of whether other diseases are complicating (what diseases, if any, should be added) is that no is recorded as 0, general diseases (such as epilepsy, gastrointestinal diseases, etc.) is recorded as 1, mental illness (anxiety, depression, etc.) is recorded as 2, developmental disorders (mental retardation, ADHD, etc.) is recorded as 3, personality disorders (paranoid, schizotypal) is recorded as 4, emotional behavior problems (aggression, self-injury, etc.) is recorded as 5; the scoring rule of if there are any allergies is that no is recorded as 0, allergy to drugs is recorded as 1, food allergy (add allergy to Ho) is recorded as 2; the scoring rule of perceptual situation is that no abnormality is recorded as 0, visual ultra/weakly sensitive (need to mark ultra or weakly sensitive) is recorded as 1, auditory hypo/hypersensitivity is recorded as 2, tactile hyper/weak sensitivity is recorded as 3, olfactory hyper/weak sensitivity is recorded as 4;

in Table 5B, the scoring rule of household income is that 0-2000 RMB is recorded as 0, 2000-5000 RMB is recorded as 1, 5000-10000 RMB is recorded as 2, 10000-50000 RMB is recorded as 3, 50000 RMB or more is recorded as 4; the scoring rule of second dependent) father's highest education is that primary and junior high school is recorded as 0, high school or college is recorded as 1, undergraduate is recorded as 2, Master's degree is recorded as 3, PhD and above is recorded as 4; the scoring rule of (first dependent) mother's highest education is that primary and junior high school is recorded as 0, high school or college is recorded as 1, undergraduate is recorded as 2. Master's degree is recorded as 3, PhD and above is recorded as 4; the scoring rule of primary caregiver is that parents is recorded as 0, (external) grandparents is recorded as 1, brothers/sisters is recorded as 2, other relatives is recorded as 3, other non-relatives (such as nannies, aunts, etc.) is recorded as 4; the scoring rule of length of time with the caregiver is that under 1 hour is recorded as 0, 1-2 hours is recorded as 1, 2-5 hours is recorded as 2, 5-8 hours is recorded as 3. 8 hours or more is recorded as 4; the scoring rule of whether the child is enrolled in school is that not enrolled is recorded as 0, entering a special education school is recorded as 1, access to institutions is recorded as 2, general school placement/inclusion is recorded as 3, normal attendance at general schools is recorded as 4;

in Table 5C, the scoring rule of different questionnaires is that all subscale scores ranged from 43.33-65.7 is recorded as 0, high P score is recorded as 1, low P score is recorded as 2, high E score is recorded as 3, low E score is recorded as 4, high N score is recorded as 5, low N score is recorded as 6; the scoring rule of self-interest is that no clear interests is recorded as 0, have 1-2 bobbies (need to list) is recorded as 1, have 3-5 hobbies and interests (need to list) is recorded as 2, have 1-2 hobbies and have a clear career orientation (need to list) is recorded as 3, have 3-5 hobbies and have a clear career orientation (need to list) is recorded as 4.

TABLE 6A
Before joining the group

| Projects | Score | Scoring Rules |
|---|---|---|
| Age of first recovery | | 0: Under 1 year old |
| | | 1: 1-3 years old |
| | | 2: 3-6 years old |
| | | 3: 6-12 years old |
| | | 4: 12-18 years old |
| Replacement rehabilitation process | | 0: Never replaced |
| (refers to physical replacement of | | 1: replaced 1-2 times, |
| rehabilitation sites, institutions, | | now stable |
| systems, etc., and does not include | | 2: replaced 3-5 times, |
| turnover of content in a unified site) | | now stable |
| | | 3: replaced more than 5 |
| | | times, now stable |
| | | 4: Not yet stable |
| Satisfaction with rehabilitation | | 0: Very dissatisfied |
| results | | 1: More unsatisfactory |
| | | 2: General effect, no merit |
| | | 3: More satisfactory, there |
| | | is some progress |
| | | 4: Very satisfied with the |
| | | greater progress |
| Rehabilitation Frequency | | 0: 3 times a day and above |
| | | 1: 1-3 times a day |
| | | 2: 3-5 times per week |
| | | 3: 1-2 times per week |
| | | 4: 3 times a month or less |
| Annual Rehabilitation Expenses | | 0: less than 5,000 yuan |
| | | 1: 5,000-10,000 RMB |
| | | 2: $10,000 to $30,000 |
| | | 3: $30,000-$100,000 |
| | | 4: 100,000 RMB or more |
| Types of rehabilitation courses | | 0: 0-1 category |
| (e.g., sensory, speech, language, | | 1: 2-3 category |
| hearing, cognitive, executive | | 2: 4-5 category |
| function, music, drawing, physical | | 3: Category 5-8 |
| education, etc.) | | 4: Class 8 or more |

TABLE 6B
After joining the group

| Projects | Score | Scoring Rules |
|---|---|---|
| Entry age | | xx months/xxxx year x month |
| (means receiving our systematic | | |
| rehabilitation program) | | |
| (or specific date) | | |
| Whether there is out group | | 0: Not at all |
| (Replacement agency) | | 1: Not at present, but after |
| Willingness | | that may |
| | | 2: Possible replacement |
| | | 3: Willing, but not yet |
| | | decided in the near future |
| | | 4: Will be replaced in the |
| | | near future |
| Satisfaction with rehabilitation | | 0: Very dissatisfied |
| results | | 1: More unsatisfactory |
| | | 2: General effect, no merit |
| | | 3: More satisfactory, there |
| | | is some progress |
| | | 4: Very satisfied with the |
| | | greater progress |
| Rehabilitation Frequency | | 0: 3 times a day and above |
| | | 1: 1-3 times a day |
| | | 2: 3-5 times per week |
| | | 3: 1-2 times per week |
| | | 4: 3 times a month or less |
| Annual Rehabilitation Expenses | | 0: less than 5,000 yuan |
| | | 1: 5,000-10,000 RMB |
| | | 2: $10,000 to $30,000 |
| | | 3: $30,000-$100,000 |
| | | 4: 100,000 RMB or more |
| Types of rehabilitation courses | | 0: 0-1 category |
| (e.g., sensory, speech, language, | | 1: 2-3 category |
| hearing, cognitive, executive | | 2: 4-5 category |
| function, music, drawing, physical | | 3: Category 5-8 |
| education, etc.) | | 4: Class 8 or more |

As shown in Tables 5A-6B, the Educational Rehabilitation Journey including before joining the group and after joining the group, wherein, the before joining the group is divided into age of first recovery, replacement rehabilitation process (refers to physical replacement of rehabilitation sites, institutions, systems, etc., and does not include turnover of content in a unified site), satisfaction with rehabilitation results, rehabilitation frequency, annual rehabilitation expenses, and types of rehabilitation courses (e.g., sensory, speech, language, hearing, cognitive, executive function, music, drawing, physical education, etc.); the after joining the group is divided into entry age (means receiving our systematic rehabilitation program or specific date), whether there is out group willingness (replacement agency), satisfaction with rehabilitation results, rehabilitation frequency, annual rehabilitation expenses, and types of rehabilitation courses (e.g., sensory, speech, language, hearing, cognitive, executive function, music, drawing, physical education, etc.);

in Table 6A, the scoring rule of age of first recovery is that under 1 year old is recorded as 0, 1-3 years old is recorded as 2, 3-6 years old is recorded as 3, 6-12 years old is recorded as 3, 12-18 years old is recorded as 4; the scoring rule of replacement rehabilitation process is that never replaced is recorded as I. replace 1-2 times and now stable is recorded as 2, replace 3-5 times and now stable is recorded as 3, replace more than 5 times and now stable is recorded as 4, not yet stable is recorded as 5; the scoring rule of satisfaction with rehabilitation results is that very dissatisfied is recorded as 0, more unsatisfactory is recorded as 1, general effect and no merit is recorded as 2, more satisfactory and there is some progress is recorded as 3, very satisfied with the greater progress is recorded as 4; the scoring rule of rehabilitation frequency is that 3 times a day and above is recorded as 0, 1-3 times a day is recorded as 1, 3- 5 times per week is recorded as 2, 1-2 times per week is recorded as 3, 3 times a month or less is recorded as the scoring rule of annual rehabilitation expenses is that less than 5000 yuan is recorded as 0, 5000-10000 yuan is recorded as 1, 10000-30000 yuan is recorded as 2, 30000- 100000 yuan is recorded as 3, 100000 yuan or more is recorded as 4; the scoring rule of types of rehabilitation courses is that 0-1 category is recorded as 0, 2-3 category is recorded as 1, 4-5 category is recorded as 2, 4-5 category is recorded as 3, 5-8 category is recorded as 4, class 8 or more is recorded as 5;

in Table 6B, the scoring rule of entry age is “xx months/xxxx year x month”; the scoring rule of whether there is out group willingness is that not at all is recorded as 0, not at present but after that may is recorded as 1, possible replacement is recorded as 2, willing but not yet decided in the near future is recorded 3, will be replaced in the near future is recorded as 4; the scoring rule of satisfaction with rehabilitation results is that very dissatisfied is recorded as 0, more unsatisfactory is recorded as 1, general effect and no merit is recorded as 2, more satisfactory and there is some progress is recorded as 3, very satisfied with the greater progress is recorded as 4; the scoring; rule of rehabilitation frequency is that 3 times a day and above is recorded as 0, 1-3 times a day is recorded as 1, 3-5 times per week is recorded as 2, 1-2 times per week is recorded as 3, 3 times a month or less is recorded as 4; the scoring rule of annual rehabilitation expenses is that less than 5000 yuan is recorded as 0, 5000-10000 yuan is recorded as 1,10000-30000 yuan is recorded as 2, 30000-100000 yuan is recorded as 3, 100000 yuan or more is recorded as 4; the scoring rule of types of rehabilitation courses is that 0-1 category is recorded as 0, 2-3 category is recorded as 1, 4-5 category is recorded as 2, 4-5 category is recorded as 3, 5-8 category is recorded as 4, class 8 or more is recorded as 5.

TABLE 7A
Autism screening dosage chart

| Projects | Score | Scoring Rules |
|---|---|---|
| Modified Infantile Autism Scale | | Projects that received 3 |
| M-CHAT (16-30 months) | | points |
| 23 entries, 4 levels of scoring, 0 | | Total Score |
| often 1 sometimes 2 occasionally 3 | | |
| never 11, 18, 20, 22 answer for 3 | | |
| points; the remaining items answer | | |
| 0 points/2, 7, 9, 13, 14, 15, 6 | | |
| scores of 3 or more in core items/ | | |
| 3 or more scores of 3 or more in 23 | | |
| questions/total score ≥17 failed | | |
| is considered as autism | | |

TABLE 7B
Autism diagnosis dosage chart

| Projects | Score | Scoring Rules |
|---|---|---|
| Childhood Autism Rating Scale | | 0: Total score <30 (non-autistic) |
| CARS (children over 2 years old) | | 1: 30-35 points and >3 points for <5 |
| 15 entries, 7-level scale, 1 normal 2 | | items (mild to moderate) |
| mildly abnormal 3 moderately | | 2: Total score of 37-60 with at least 5 |
| abnormal 4 severely abnormal; 0.5 | | items >3 (severe) |
| option in the middle | | |
| Autism Behavior Inventory | | 0: Total score ≤31 points |
| ABC (8 months-28 years) | | 1: 31 points < total score ≤ 53 points |
| 57 entries, including 5 areas of | | 2: 53 points < total score ≤ 67 points |
| sensory ability (S), interaction ability | | 3: Total score >67 points |
| (R), motor ability (B), language | | |
| ability (L), and self-care ability (S) | | |
| A total score ≥31 was used as the | | |
| threshold score for autism screening; | | |
| a total score >53 was used as the | | |
| threshold score for autism diagnosis | | |
| (reference value) | | |
| Autism Diagnostic Observation | | 0: Total score <7 (non-autistic) |
| Scale | | 1: 7 < total score ≤ 11 (autism |
| ADOS (2 years old and above) | | spectrum) |
| TM Module: Infant and Toddler | | 2: Total score >12 (autism) |
| Module, Toddler Module for | | |
| preschool aged 12-30 months | | |
| with/without language. | | |
| Module M1: for children without | | |
| language. | | |
| Module M2: for children of any age | | |
| but who are not fluent in oral | | |
| expression. | | |
| M3 module: for children and | | |
| adolescents who are fluent in oral | | |
| expression. | | |
| M4 Module: For older adolescents | | |
| and adults who are fluent in oral | | |
| expression. | | |

TABLE 7C
Other psychological assessment scales

| Projects | Score | Scoring Rules |
|---|---|---|
| Wechsler Intelligence Scale | | Total score. |
| (6-16 years old) | | Verbal Comprehension Index. |
| | | Perceptual Reasoning Index. |
| | | Working Memory Index. |
| | | Processing speed index. |
| Psychoeducational Assessment Scale | | Standard score/developmental age. |
| PEP-3 | | Communication (C) Total score. |
| (2-12 years old) | | Cognitive: Language Expression: |
| 7 functional development scales and 5 | | Language Comprehension. |
| pathological behavior scales totaling | | Total physical fitness (M) score. |
| 139 entries | | Small muscles: Large muscles: Imitation |
| | | (visual/motor): |
| | | Total Behavior (MB) Score. |
| | | Emotional expression: social interaction: |
| | | behavioral traits-nonverbal; behavioral |
| | | traits-verbal |
| Picture Vocabulary Test Chinese | | 1 point for a correct answer, 0 points for |
| Revised Version PPVT-R | | a wrong answer. |
| (2 years 6 months-adult) | | Registration by actual score |
| The total score is 125 points, 1 point | | |
| for correct answer, 0 points for wrong | | |
| answer | | |
| Verbal Behavioral Milestone | | Register the total score, the higher the |
| Assessment and Placement Program | | score the more serious the problem |
| VB-MAPP Disorder Assessment | | Below 0: 20 minutes, fusion |
| 24 items, 4 levels of scoring | | 1: 20-25 minutes, shadow teacher |
| | | 2: 25-35 minutes, group |
| | | 3: 35-50 points, group + individual |
| | | training |
| | | 4: 50 points or more, individual training |

As shown in Tables 7A-7C, commonly used assessment scales for autism which is optionally done assessments depending on the age of the child, including autism screening dosage chart, autism diagnosis dosage chart, other psychological assessment scales; each test should be marked with the age of the test;

in Table 7A, the autism screening dosage chart including Modified Infantile Autism Scale, M-CHAT (16-30 months), the scoring rule is the total score of projects with 3 points;

in Table 7B, the autism diagnosis dosage chart including Childhood Autism Rating Scale CARS (children over 2 years old), Autism Behavior Inventory ABC (8 months-28 years), Autism Diagnostic Observation Scale ADOS (2 years old and above); the scoring rule of CARS is that total score<30 (non-autistic) is recorded as 0, 30-35 points and >3 points for <5 items (mild to moderate) is recorded as 1, total score of 37-60 with at least 5 items>3 (severe) is recorded as 2; the scoring rule of ABC is that total score≤31 points is recorded as 0, 31 points<total score≤53 points is recorded as 1, 53 points<total score≤67 points is recorded as 2, total score>67 points is recorded as the scoring rule of ADOS is that total score<7 (non-autistic) is recorded as 0, 7<total score≤11 (autism spectrum is recorded as 1, total score>12 (autism) is recorded as 2;

in Table 7C, the other psychological assessment scales including Wechsler intelligence Scale (6-16 years old), Psychoeducational Assessment Scale PEP-3 (2-12 years old), Picture Vocabulary Test Chinese Revised Version PPVT-R (2 years 6 months-adult), Verbal Behavioral Milestone Assessment and Placement Program VB-MAPP; the scoring rule of Wechsler intelligence Scale is the total score of Verbal Comprehension Index, Perceptual Reasoning index, Working Memory index and Processing speed index; the scoring rule of PEP-3 is that the score is including Standard score/developmental age, Communication (C) Total score, Total physical fitness (M) score, and Total Behavior (MB) Score; the scoring rule of PPVT-R is that 1 point for a correct answer, 0 points for a wrong answer, registration by actual score; the scoring rule of VB-MAPP is that register the total score, the higher the score the more serious the problem.

The results of each project (in figures) are taken as an evaluation indicator, and 34 indicators are tentatively calculated at the same level, so the absolute value |W| of the indicator weight is temporarily set to 1. When the evaluation indicator is a positive indicator (the positive indicator means that the higher the score in the scoring rule, the better the actual situation of the child, and the neutral indicator is not considered here), W=1, the negative indicator, W=−1, and the initial score of each child is set to 100. Since there are five levels of scoring, four levels of scoring, three levels of scoring, and special scoring in the scoring rule, here for the consistency of the scoring rules. Those that can be converted into a 5-point scoring system will be unified into a 5-point scoring system. The specific calculation method is as follows.

1. Level 5 scoring index items

a. Definition: It refers to the items with 5 different scoring indicators (0, 1, 2, 3, 4) in the scoring rule, which may include positive indicator items and negative indicator items.

b. Examples of positive indicator items:

Project: Self-interest

Scoring rules: 0: no clear interests; 1: Have 1-2 hobbies; 2: Have 3-5 hobbies; 3: Have 1-2 hobbies and clear career guidance; 4: There are 3-5 hobbies and clear career guidance.

Calculation method: read the score of the corresponding cell in the table and record it as a, a can be a value of 0, 1, 2, 3, 4 score=score+a*W, where W=1.

c. Examples of negative indicators:

Project: Language Behavior Milestone Assessment and Resettlement VB-MAPP Obstacle Assessment

Point rule: register the total score. The higher the score, the more serious the problem; 0: below 20 points, integration; 1: 20-25 points, shadow teacher; 2: 25-35 points, group; 3: 35-50 points, group+individual training; 4: More than 50 points, individual training.

Calculation method: the score of the corresponding cell in the reading table is recorded as b, and b can be one of 0, 1, 2, 3, or 4. The total score is score=score+b*W, where W=−1.

2. Level 4 scoring index items

a. Definition: refers to the items with 4 different scoring indicators (0, 1, 2, 3) in the scoring rule, which may include positive indicator items and negative indicator items.

b. Examples of positive indicator items: None

c. Examples of negative indicators:

Item: Autism Behavior Scale ABC

Point rule: 0: total score≤31 points; 1: 31 points<total score≤53 points; 2: 53 points<total score≤67 points; 3: Total score>67; The total score≥31 is the threshold score of autism screening; The total score>53 is taken as the diagnostic threshold score of autism (reference value).

Calculation method: Read the score of the corresponding cell in the table and record it as e, where e can be one of 0, 1, 2 or 3. The first level score is converted to the fifth level score, that is, e=(e/4)*5, and then included in the total score=score+e*W, where W=−1.

3. Level 3 scoring index items

a. Definition: It refers to the items with 3 different scoring indicators (0, 1, 2) in the integral rules, which may include positive indicator items and negative indicator items.

b. Examples of positive indicator items:

Item: Age of diagnosis (the smaller the better)

Scoring, rule: 0: ≥6 years old (72 months); 1: 3-6 years old (36 months to 72 months); 2: Less than or equal to 3 years old (36 months).

Calculation method: Read the score of the corresponding cell in the table and record it as c, and c can be a value of 0, 1, or 2. First convert the grade 3 score to the grade 5 score, that is, c=(c/3)*5, and then count it into the total score=score+c*W, where W=1.

c. Examples of negative indicators:

Item: Children Autism Rating Scale CARS

Scoring rules: 0: total score<30 (non-autism); 1: 30-35 points, and the items with more than 3 points are less than 5 (mild to moderate); 2: The total score is 37-60, and at least 5 items are more than 3 points (severe);

Calculation method: Read the score of the corresponding cell in the table and record it as d, and d can be a value of 0, 1, or 2. First convert the grade 3 score to grade 5 score, that is, d=(d/3)*5, and then record it into the total score=score+d*W, where W=−1.

4. Special scoring items:

a. Definition: Scoring rules do not give scores similar to 0, 1, 2, 3 and 4 grades.

b. Specific items: Modified infant autism scale M-CHAT; Wechsler Intelligence Scale; PEP-3, a Chinese version of picture vocabulary test PPVT-R;

c. Calculation method of each specific evaluation (if not tested, the score of this item is 0)

Project: Modified infant autism scale M-CHAT

Scoring rules: 2 or more than 3 points in 2, 7, 9, 13, 14, 15. 6 core projects or 3 or more than 3 points in 23 questions or a total score of ≥17 points will be considered as autism.

Calculation method: the total score of the corresponding cell in the reading table is s, and the total score is score=score+(s−17)*W, where W=−1.

Item: Wechsler Intelligence Scale (full score of 75)

Point rule: total score: 25-40 (severe) 40-55 (moderate) 55-75 (mild)

Calculation method: read the total score of the corresponding cell in the table as s, convert s into a 5-point system and count it into the total score=score+((s/75)*5)*W, where W=1.

Project: Psychological Education Assessment Scale PEP-3 (tentative 139 full marks)

Scoring rules: 139 items in 7 functional development scales and 5 pathological behavior scales

Calculation method: read the total scores of C, M and MB of the corresponding cells in the table and add them to s, convert s into a 5-point system and count them into the total score=score+((s/139)*5)*W, where W=1.

Item: Picture Vocabulary Test Chinese Revision PPVT-R (125 full marks)

Points rule: the total score is 125 points, 1 point for correct answers and 0 point for wrong answers

Calculation method: read the total score of the corresponding cell in the table as s, convert s into a 5-point system and count it into the total score=score+((s/125)*5)*W, where W=1.

5. Neutral scoring index

a. Definition: In scoring rules, there are only differences between 0 and 1, 2, 3, 4 and 5, which correspond to different problems. The scores of these indicators do not represent whether they are beneficial to the rehabilitation of autism.

b. Project examples: perception (whether there are other diseases, whether there are allergies, whether children are enrolled in school, and parents' personality)

c. Integral rule: 0: no exception; 1: Visual hypersensitivity/weak sensitivity (hypersensitivity or weak sensitivity shall be marked); 2: Hearing hypersensitivity/hyposensitivity; 3: Tactile hypersensitivity/hyposensitivity; 4: Olfactory hypersensitivity/hyposensitivity. The five scores here only represent a situation, and do not distinguish the size of numbers, that is, they cannot indicate whether these sensitive categories are beneficial to the recovery of autism.

Calculation method: Read the score s in the table, that is, the number of s is recorded as n. If s=0, then the score remains unchanged. If s is not 0, then s=n, score=score+s*W, where W=−1, that is, score=score+n*W, where W=−1.

In the invention, the capacity measurement value C^{v} is calculated using a tree data structure. The children were measured with the scale used in the assessment of speech articulation, social competence and executive function, and the results were sorted out. The three competencies are shown in Table 8, Tables 9A-9C, and Table 10.

TABLE 8
Mandarin consonant articulation (7 items)

| Bilabial/labiodental | /m//b//p//f//v/ |
|---|---|
| dentolabial | /z//c//s/ |
| alveolar/alveolopalatal | /n//d//t//l/ |
| postalveolar/retroflex | /zh//ch//sh//r/ |
| alveolar | /j//q//x/ |
| velar | /g//k//h/ |
| the four tones | 1, 2, 3, 4 |

TABLE 9A

| Title | |
|---|---|
| No. | Title |
| 1 | Children are able to consistently look into the eyes and face of others when they greet or |
| | speak to them |
| 2 | Children can respond when called by name (e.g., show expressions of surprise) |
| 3 | When a caregiver is present (e.g., returns after a period of absence), the child is able to |
| | approach the caregiver and express attachment emotions (e.g., approaches the mother |
| | and extends arms for her to hold) |
| 4 | Children can express their affection for their caregivers through words or actions, etc. |
| 5 | Children respond to caregivers with smiles or other happy sounds when caregivers |
| | interact with them |
| 6 | The child is able to attract the caregiver's attention with a smile or sound when the |
| | caregiver interacts with the child |
| 7* | When you look in the mirror, you will “interact” with yourself in the mirror (such |
| | as staring, touching with your hands, kissing with your mouth, etc.) |
| 8 | Knowing what is their own, such as knowing that clothes and toys are “mine” |
| 9 | When listening to a story, children can sit quietly and listen to the whole story |
| 10 | Children know and can respond to their age (indicated by the number of fingers or by |
| | spoken responses) |
| 11 | Children know and can answer their own names |
| 12 | The child knows and can answer the name of the father or mother |
| 13 | Children understand the emotion of guilt and can say “I'm sorry” when they break |
| | something |
| 14 | Children can understand the emotion of appreciation and express praise verbally or |
| | through actions (e.g., saying “you're great” or giving a thumbs-up, applause, |
| | etc.) when they find good behavior or good work by others |
| 15* | Children are able to control themselves from doing something when asked to “not do |
| | something” |
| 16* | Children are able to make simple comments about their behavior when asked about |
| | performance (e.g., good or bad performance) |
| 17 | Children can express requests through gestures or words when there is something they |
| | want |
| 18 | When entering a new environment, children can become interested in the new |
| | environment and the people in the new environment |
| 19 | Children can wave and say “Hello XX” when others wave hello to them |
| 20 | Children are able to share with others when playing with toys or eating snacks when |
| | joined by others |
| 21 | How do children react when a stranger approaches? |
| 22 | How do children react when strangers talk to them? |
| 23 | How do children react when answering the phone to hang up? |
| 24 | How do children react when meeting with others? |
| 25 | How do children react when their caregivers suddenly leave? |
| 26 | How do children react when they receive something or a gift from someone else? |

TABLE 9B

| Title | | | | | |
|---|---|---|---|---|---|
| No. | 0 | 1 | 2 | 3 | 4 |
| 1 | No | Yes | | | |
| 2 | No | Yes | | | |
| 3 | No | Yes | | | |
| 4 | No | Yes | | | |
| 5 | No | Yes | | | |
| 6 | No | Yes | | | |
| 7* | No | Yes | | | |
| 8 | No | Yes | | | |
| 9 | No | Yes | | | |
| 10 | No | Yes | | | |
| 11 | No | Yes | | | |
| 12 | No | Yes | | | |
| 13 | No | Yes | | | |
| 14 | No | Yes | | | |
| 15* | No | Yes | | | |
| 16* | No | Yes | | | |
| 17 | No | Yes | | | |
| 18 | No | Yes | | | |
| 19 | No | Yes | | | |
| 20 | No | Yes | | | |
| 21 | No response | Ability to focus | There will be | Will quickly | |
| | | on strangers with | appropriate | find caregivers | |
| | | eye contact | dodging | | |
| 22 | No reaction or | Can talk briefly | Can take the | Able to | |
| | dodge | with strangers | initiative to | maintain a | |
| | | | greet and | conversation | |
| | | | introduce | with strangers | |
| | | | themselves, | | |
| | | | such as “Hello, | | |
| | | | I am XX” | | |
| 23 | Hang up directly | Response to “XX | Responding to | Respond to | |
| | | Goodbye” | “XX goodbye” | “XX goodbye” | |
| | | | and showing | and be able to | |
| | | | emotions of | express miss | |
| | | | reluctance | | |
| 24 | No response | Does not initiate | Does not | No active | No active |
| | | greetings, but | initiate | greeting, but | greeting, but |
| | | can respond with | greetings, but | can respond | can respond |
| | | a smile | can reach out | with “yes” | with “XX |
| | | | or hold hands | | good” |
| | | | in response | | |
| 25 | No response | Saying | There is a | There are | Awareness of |
| | | “bye”/waving | slight reaction, | obvious | following the |
| | | mechanically | such as the | reactions, such | caregiver, |
| | | | arms swinging | as crying as the | with |
| | | | to show | caregiver walks | significant |
| | | | tension | away | changes in |
| | | | | | mood as the |
| | | | | | caregiver |
| | | | | | moves away |
| 26 | No response | Expressing | Can take the | | |
| | | gratitude with | initiative to say | | |
| | | gestures or | “Thank you | | |
| | | actions when | XX” | | |
| | | prompted by the | | | |
| | | caregiver | | | |

TABLE 9C

| Title | | | | | |
|---|---|---|---|---|---|
| No. | 5 | 6 | 7 | 8 | 9 |
| 1 | | | | | |
| 2 | | | | | |
| 3 | | | | | |
| 4 | | | | | |
| 5 | | | | | |
| 6 | | | | | |
| 7* | | | | | |
| 8 | | | | | |
| 9 | | | | | |
| 10 | | | | | |
| 11 | | | | | |
| 12 | | | | | |
| 13 | | | | | |
| 14 | | | | | |
| 15* | | | | | |
| 16* | | | | | |
| 17 | | | | | |
| 18 | | | | | |
| 19 | | | | | |
| 20 | | | | | |
| 21 | | | | | |
| 22 | | | | | |
| 23 | | | | | |
| 24 | Can initiate | Able to shake | Can wave | Able to greet | Can greet |
| | greetings with a | hands and | hello when | people with | people with |
| | handshake | respond with | seen from | “Hello XX” | “hello” and |
| | | “good | a distance | and shake | shake hands |
| | | morning/good | | hands | |
| | | evening” | | | |
| 25 | Immediately | Follow the | Responding to | Responding to | Respond |
| | follows the | caregiver and | the “bye”, but | “bye-bye” and | “bye” and |
| | caregiver, | allow the | there is a | being able to | make |
| | blocks the | caregiver to leave | reluctant | wave goodbye | requests, |
| | caregiver's | after expressing | emotion | voluntarily | such as |
| | progress, and | reluctance with | | | come back |
| | there is a | kisses, etc. | | | early/buy |
| | noticeable | | | | me . . . |
| | change in mood | | | | |
| 26 | | | | | |

As shown in Table 9A, there are 26 questions used to assess the social ability of autistic children; as shown in Tables 9B and 9C, different evaluation questions are given different scores according to the answers.

TABLE 10

| | | | |
|---|---|---|---|
| 1. Fidgeting | No | Sometimes | Frequently |
| 2. Refuses or has difficulty accepting different approaches to | No | Sometimes | Frequently |
| solving problems in schoolwork, friendships, and tasks | | | |
| 3. When given three things to do, remember only the first or last | No | Sometimes | Frequently |
| one | | | |
| 4. Be unaware of how their behavior affects or disturbs others | No | Sometimes | Frequently |
| 5. Sloppy work | No | Sometimes | Frequently |
| 6. will be furious | No | Sometimes | Frequently |
| 7. Unprepared for how to complete school assignments | No | Sometimes | Frequently |
| 8. Can't find (what you need) in the room or on the desk | No | Sometimes | Frequently |
| 9. Will not take the initiative to start something on their own | No | Sometimes | Frequently |
| 10. Not thinking before acting (impulsive) | No | Sometimes | Frequently |
| 11. Difficult to get used to a new environment (class, group, | No | Sometimes | Frequently |
| friends, etc.) | | | |
| 12. Short attention span | No | Sometimes | Frequently |
| 13. Insufficient awareness of your strengths and weaknesses | No | Sometimes | Frequently |
| 14. Unexplained emotional outbursts (losing one's temper, | No | Sometimes | Frequently |
| crying out, laughing out loud) | | | |
| 15. Sticking to the details and ignoring the big picture | No | Sometimes | Frequently |
| 16. More likely to lose control than a partner | No | Sometimes | Frequently |
| 17. Obsessed with a topic or activity | No | Sometimes | Frequently |
| 18. Will forget their names | No | Sometimes | Frequently |
| 19. Difficult to complete tasks with more than one step (more | No | Sometimes | Frequently |
| complex, difficult to complete in one step) | | | |
| 20. unaware that certain behaviors disturb others | No | Sometimes | Frequently |
| 21. Poor organization of written work | No | Sometimes | Frequently |
| 22. Small things inspire big reactions | No | Sometimes | Frequently |
| 23. Have good ideas but do not put them into practice (lack of | No | Sometimes | Frequently |
| implementation) | | | |
| 24. Inappropriate timing of the conversation | No | Sometimes | Frequently |
| 25. Difficulty in completing tasks (class assignments, | No | Sometimes | Frequently |
| homework, etc.) | | | |
| 26. Not paying attention to the negative reactions of others causer | No | Sometimes | Frequently |
| by one's actions | | | |
| 27. reacts more strongly to the environment than other children | No | Sometimes | Frequently |
| 28. Difficulty remembering things, even after just a few minutes | No | Sometimes | Frequently |
| 29. Make careless mistakes | No | Sometimes | Frequently |
| 30. leaving your seat at inappropriate times | No | Sometimes | Frequently |
| 31. Becoming distracted when in a new environment | No | Sometimes | Frequently |
| 32. Difficulty concentrating on schoolwork, etc. | No | Sometimes | Frequently |
| 33. Poorly written | No | Sometimes | Frequently |
| 36. Difficulty in counting from one to three | No | Sometimes | Frequently |
| 37. Made a mess that others had to help clean up | No | Sometimes | Frequently |
| 38. Need to be told (by others) to start a task, even if willingly | No | Sometimes | Frequently |
| 39. Behaving too wildly or “out of control” | No | Sometimes | Frequently |
| 40. Thinking too much about the same issue over and over again | No | Sometimes | Frequently |
| 41. Forgetting what he/she was about to do on his/her own | No | Sometimes | Frequently |
| (riding a donkey to find a donkey) | | | |
| 42. Not checking for errors in assignments | No | Sometimes | Frequently |
| 43. Episodes of anger or crying that are violent but end abruptly | No | Sometimes | Frequently |
| 44. Unable to take on big and difficult tasks | No | Sometimes | Frequently |
| 45. Loss of lunch boxes, lunch money, access documents | No | Sometimes | Frequently |
| homework, etc. | | | |
| 46. Needing adult help to stick to a task | No | Sometimes | Frequently |
| 47. Forgetting to turn in homework, even if it's done | No | Sometimes | Frequently |
| 48. Difficulty in discontinuing one's behavior | No | Sometimes | Frequently |
| 49. Refusal of changes in daily life, diet, location, etc. | No | Sometimes | Frequently |
| 50. Difficult to initiate to start to complete the task | No | Sometimes | Frequently |
| 51. Emotions are easily influenced by the environment | No | Sometimes | Frequently |
| 52. Underestimating the time needed to complete the task | No | Sometimes | Frequently |
| 53. Do not bring home homework, workbooks, materials, etc. | No | Sometimes | Frequently |
| 54. Can't find the school gate | No | Sometimes | Frequently |
| 55. No initiative | No | Sometimes | Frequently |
| 56. highly distractible | No | Sometimes | Frequently |
| 57. Start completing assignments at the last minute | No | Sometimes | Frequently |
| 58. Not considering the consequences before acting | No | Sometimes | Frequently |
| 59. Not knowing their proper behavior (role) in the group | No | Sometimes | Frequently |
| 60. Difficult to use different approaches to solve the same problem | No | Sometimes | Frequently |
| 61. Doing poorly on the test even though you know the correct | No | Sometimes | Frequently |
| answer | | | |
| 62. Not completing homework | No | Sometimes | Frequently |
| 63. When problem solving is difficult, it is difficult to think of a | No | Sometimes | Frequently |
| different way to solve the problem | | | |

One first recalls the previously introduced definition of the evaluation-value C^{v}:

C^{v}:=[C^{a} C^{s} C^{f}]^{T}

Building upon this construct, this section generalizes the representation and the calculation of the evaluation-value C^{v} with the tree data structure in computer science:

(a) At the k^{th} level of the tree, there exist a total of lₖ nodes, uniquely identified with the numbering 1, 2, . . . , lₖ. As a slight abuse of notation, lₖ is also used as the index to retrieve the particular node, in other words:

lₖ ∈{1, 2, . . . , lₖ}

The Assessment-Tree M. This setup yields the subsequent definition of the assessment-tree M., where each node represents, as its namesake suggests, one item of assessment. The zeroth (0^{th}) level of the assessment-item tree M. encompasses the three fundamental aspects of evaluation for the autism spectrum as established earlier:

$$M ( {l}_{0} ) := \{ \begin{matrix}acoustic ability & {l}_{0} = 1 \\ social comm & {l}_{0} = 2 \\ \text{?} execution & {l}_{0} = 3\end{matrix}$$

$$\text{?} \text{indicates text missing or illegible when filed}$$

In other words, speech articulation constitutes the first zeroth level assessment-item, social communication the second and functional execution the third.

Complementary to the assessment-tree M is the scoring-tree C, where each node denotes an individual's score for the corresponding assessment-item as defined in the assessment-tree counterpart M. As indicated previously, the scores in the three zeroth level assessment-items are captured by the variables C^{a} and C^{s}, C^{f} respective.

Proceeding towards the following, first (1^{st}) level of the scoring-tree, one notes, as an example, 8 first-level 1_{I}children-nodes bound to the second zeroth level node »social-communication«, denoted as follows:

$$\text{?} = ( [ \begin{matrix}{l}_{0} = 2 \\ {l}_{1} ∈ [ 1 , ⋯ , 8 )\end{matrix} ] )$$

$$\text{?} \text{indicates text missing or illegible when filed}$$

Conforming to the stated dimension of 8 for the vector of social-communication C.

The following formula captures the »bottom-up« recursive routine to calculate the values at each node of the scoring tree C:

$$\text{?} := {avg}_{*} \{ \text{?} \}$$

$$\text{?} \text{indicates text missing or illegible when filed}$$

Specifically, the score of a node on the x^{th} level is computed by averaging the scores of all its (x+1)^{th} level children. Extending the previous example, one would thus calculate the zeroth level social-communication score as the average of all its 8 children node-scores on the first level.

To obtain the scoring-values of the nodes themselves, one distinguishes among various, level-specific calculation methods. The following paragraphs enumerate these computation rules up to the second level nodes.

For each of the currently existing 109 second level nodes, test-based evaluations are carried out to directly determine the corresponding node-score. In particular, 1 point is awarded for fully passing the corresponding test item, 0.5 for partially passing and 0 for failing. The point-values are subsequently registered as the final scores of the second level nodes that these tests respectively target at.

To aid results presentation and understanding, the scores are linearly normalized such that the processed scoring maximum of every node is 10. The procedure of such linear normalization is generalized with:

$$e = \frac{{e}^{raw}}{{e}^{full}} * 10$$

Where and e^{raw} and e^{full} denote the pre and post processing data respectively.

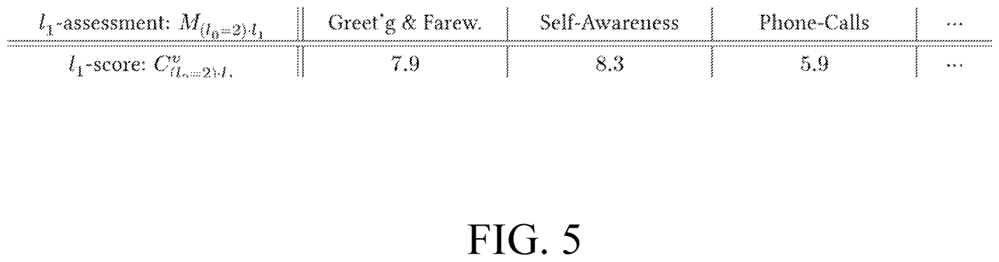

As an example, the FIG. 5 presents an excerpt of three level-one scores measured respectively for the assessment fields of (1) Greetings and Farewell; (2) Self awareness; (3) Conversation over phone-call which are attached to the level-zero assessment node »social-communication skills« identified with l₀=2:

As described previously, the score of a first level node is computed as the average of its second-level children. Building upon the previous example, where all its children-nodes scores (of the first level) are known, the final node-value of social-communication skills (of zeroth level) is found as follows:

$$\begin{matrix}{C}_{{l}_{0} - 2} := \text{?} \\ := \vec{weights} ∘ \text{?} \\ := [ \begin{matrix}1 / 8 \\ 1 / 8 \\ 1 / 8 \\ ⋮\end{matrix} ] ∘ [ \begin{matrix}7.9 \\ 8.3 \\ 5.9 \\ ⋮\end{matrix} ] \} ∈ {ℝ}^{8} \\ ≡ 7.1\end{matrix}$$

$$\text{?} \text{indicates text missing or illegible when filed}$$

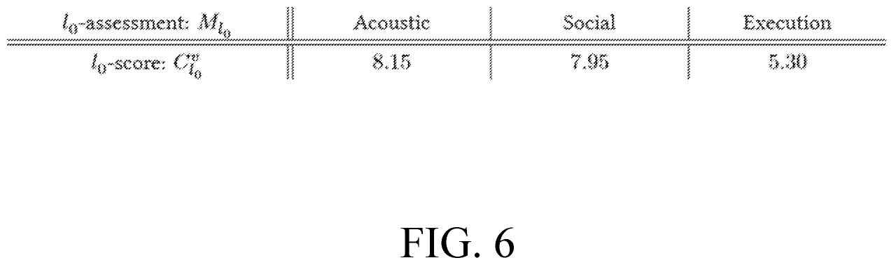

To conclude this chapter of discussion on the inner workings of the assessment and scoring-tree, the FIG. 6 demonstrates a sample individual's l₀-scoring chart:

As stated previously, methods revolving around the linear-regression model are deployed to associate the evaluation-values C^{v} and the occupation-suitability values s. Adaptation details for the usage of linear-regression are provided as follows; rigorous analyses and mathematical proofs of this modeling methodology abound in literature materials on statistics and machine-learning.

With the loss-function of linear-regression defined as:

$$\begin{matrix}{L}^{lin - regr} := {\sum }_{i} \{ {l}_{i}^{lin - regr} \} \\ {\sum }_{i} \{ {( {y}_{i} - w ∘ {x}_{i} )}^{2} \}\end{matrix}$$

the following optimization-problem is induced for the model:

$$\begin{matrix}{w}^{*} := arg {min}_{w ∈ ℝ} \{ {L}^{lin - regr} \} \\ ≡ arg {min}_{w} \{ {\sum }_{i} \{ {( {y}_{i} - w ∘ {x}_{i} )}^{2} \} \}\end{matrix}$$

where the optimize w* minimizes the of loss-function.

The two well-known methods used to calculate the optimizer w* are introduced below:

Closed-form solution an analytic solution from linear-algebra provides the following closed-form formula for w*

w*=(X^{T} X)⁻¹ X^{T} Y

where the variables are understood as follows
X:=evaluation-values (vectors) of every student xᵢ, vertically stacked ∈ [symbol] ^{i×25}
Y:=occupation-suitability-values (scalar) of every student yᵢ, vertically stacked ∈ [symbol] Rⁱ
w:=model weight

In particular, the i^{th} row of matrix X is the transposed) evaluation-values xᵢ ∈ [symbol] ²⁵ of th i^{th} of the i^{th} student, whereas the i^{th} scalar of vector Y is the occupation-suitability yᵢ ∈ [symbol] ¹ of the same i^{th} student.

On the other hand, the iterative method of gradient-descent based on the general formula of:

wₜ₊₁:=hd t−ηₜgrad{L}

Which is also applicable as a solution for the linear-regression problem. Specifically, the gradient of the loss-function as defined for the linear-regression problem is found with:

$$\begin{matrix}grad \{ L \} = grad {\sum }_{i} \{ {( {y}_{i} - w ∘ {x}_{i} )}^{2} \} \\ \text{?} {\sum }_{i} \{ grad \{ {( {y}_{i} - w ∘ {x}_{i} )}^{2} \} \} \\ ≡ {\sum }_{i} \{ 2 ( {y}_{i} - w ∘ {x}_{i} ) \text{?} \} \\ ≡ 2 {\sum }_{i} \{ {r}_{i} \text{?} \}\end{matrix}$$

$$\text{?} \text{indicates text missing or illegible when filed}$$

Thus, the iteration formula for gradient descent is given as:

$$\begin{matrix}{w}_{l + 1} := {w}_{t} - {η}_{t} grad \{ L \} \\ := {w}_{t} - 2 {η}_{t} {\sum }_{i} \{ {r}_{i} \text{?} \} \\ ≡ {w}_{t} - 2 {η}_{t} {\sum }_{i} \{ ( {y}_{i} - w ∘ {x}_{i} ) \text{?} \}\end{matrix}$$

$$\text{?} \text{indicates text missing or illegible when filed}$$

where ηₜ denotes the learning-rate, which, in the case of the linear-regression model, defaults to:

η≡0.5

as stated in machine-learning literature.

As shown in Listing 1 below, the source-code excerpt in the python programming-language with the sklearn machine-learning library demonstrates the conceptual implementation to obtain the weights w of the linear-model as described above. Note that in the context of machine-learning, this procedure of model-calculation is referred to as the »training step«.

Listing I

1 #read input-data of assessment and suitability values

2 d_train=np.loadixt(“./file_train”)

3 #extract data-pair for training:assessment and suitability

4 x_tr, y_tr=d_train[:,2:], d_train[:,1]

6 from sklearn import linear_model

7 model=linear_model.LinearRegression( )

8 #train the model to find its weights

9 model.fit(x_tr, y_tr)

With a sufficient sample reservoir of participating students, the training-step as delineated above is carried out, yielding a fully specified linear-regression model. This enables the subsequent »prediction-step«, where the occupation suitability value of a newly arriving student [symbol] new, of which only the evaluation-values x_{new} are available, is literally»predicted« with the now deterministic model in the following manner:

$$\text{?}$$

$$\text{?} \text{indicates text missing or illegible when filed}$$

The hat-superscript seen in [symbol] _{new} denotes the very nature of its generation via the regression model, in contrast to the actual, »real«counterpart y_{new} without this notational detail.

As a side-note, observe that, in adherence with the standard notation etiquette of machine-learning, the evaluation-values and the occupation-suitability, previously denoted as C and s respectively, are represented by x and y in the formulae presented above.

To conclude the investigation of applying the linear-regression model to predict the occupation-suitability s with the evaluation-values C, one observes the following illustrative formula:

$${ℝ}^{25} ∋ \begin{matrix}{\underbrace{{C}^{c} ⊕ {C}^{v}}}_{C} & {\to }^{lin - regr} & s ∈ {ℝ}^{1}\end{matrix}$$

where ⊕ denotes vector-concatenation.

Analogous to the previous source-code snippet on training the linear-regressor, the following excerpt (as shown in Listing 2) demonstrates the implementation of the prediction-step as outlined above:

Listing 2

1 #read input-data of assessment values of new students

2 x_new=np.loadtxt(“./file_new”)

4 #find occupation-suitability values with model

5 y_new=model.pred(x_new)

The invention also proposes a system for realizing the information technology of autistic children's development process and career prediction method. The system includes a data input module, a database module, a machine learning module, a prediction module, and an output module; Among them,

The data entry module is responsible for entering the development information of autistic children, the diagnosis information of autistic children, the assessment score of the consonant articulation of autistic children, the social interaction assessment score, and the executive function brief2 scale score;

The database module is responsible for storing and screening the input development information and diagnosis results of autistic children, as well as the assessment scores of autistic children's consonant articulation, social interaction and executive function brief2 scale scores; The filtering is to filter the data according to the required model and model characteristics;

Machine learning module, which is responsible for learning and establishing the occupational prediction model of autistic children using the machine learning algorithm library (such as sklearn) in Python language, and obtaining the weight value of various autistic children's characteristics in this model for the future occupation of autistic children;

The prediction module is responsible for substituting the input development information, diagnosis result information of autistic children, assessment scores of autistic children's consonant articulation, social communication positioning atlas (i.e., the number of green dots in each category of Archimedes spiral curve), and executive function brief2 scale scores into the established and calculated model for prediction;

The output module is used to output the suitable occupation for autistic children in the future.

The invention also provides a method for evaluating and recommending the effect of the rehabilitation course for autistic children. The underlying logic of the course evaluation and the function evaluation is consistent, but the expression is different. That is, the same tree data structure and bottom-up iteration method are adopted. However, when different test materials are selected, this test method is named as quick test method. The quick test method refers to scoring the abilities that children should learn in this lesson with a unified standard before and after the class to evaluate the content and proficiency of children's learning in this lesson, that is, classroom efficiency. The difference between children's after class score and pre class score is the progress value of this lesson, that is, how much children have improved their speech articulation, social ability and executive function through this lesson. The methods for evaluating and recommending the effects of the rehabilitation course for autistic children include the following steps:

Step I: Current state at tₖ

Sub-step A: At the onset of the k^{th} time-step tₖ, the course-database is composed of lesson-modules 1,2-j: which have been visited by a total of nₜ_{ₖ}¹, nₜ_{ₖ}², . . . , nₜ_{ₖ}^{j}; students respectively. For each of these j lesson-modules, the average improvement-value of all the participating students is denoted as: Δ̅ₗ̅_̅{̅ₖ̅}̅¹̅, Δ̅ₗ̅_̅{̅ₖ̅}̅²̅, . . . , Δ̅ₗ̅_̅{̅ₖ̅}̅^̅{̅j̅}̅, respectively:

Sub-Step B: To advance to the next time-step a total of students(1,2-i) attending the lesson-module, demonstrate respective scoring of:

l^{lesson}^{ⱼ}^{;student}^{ₖ}=:l^{j,i}

In accordance to the rapid-evaluation method as previously introduced;

Sub-Step C: the improvement-values of the students: Δₜ_{ₖ}^{j,1}, Δₜ_{ₖ}^{j,2} . . . Δₜ_{ₖ}^{j,i}, are subsequently calculated.

Step II: Evolution to tₖ→t_{k+I};

(a) The evolution-strategy of the number of participating students is readily available as:

nₜ_{ₖ₊₁}^{j}:=nₜ_{ₖ}^{j}+i

(b) The average improvement-value of lesson-module j is updated with:

$$\begin{matrix}\text{?} := \frac{1}{\text{?} + i} [ \begin{matrix}\text{?} \\ 1 \\ ⋮ \\ 1\end{matrix} ] ∘ [ \begin{matrix}\text{?} \\ \text{?} \\ ⋮ \\ \text{?}\end{matrix} ] \\ ≡ \frac{1}{\text{?}} [ \begin{matrix}\text{?} \\ 1\end{matrix} ] ∘ [ \begin{matrix}\text{?} \\ {\sum }_{i} \{ \text{?} \}\end{matrix} ]\end{matrix}$$

$$\text{?} \text{indicates text missing or illegible when filed}$$

The formula is seen as follows: the weighted average of the average improvement-values of lesson j as of the k^{th} time step Δ̅ₗ̅_̅{̅ₖ̅}̅^̅{̅j̅}̅ and the individual improvement-value of every newly participating student

Δₜ_{ₖ}^{j,1}, Δₜ_{ₖ}^{j,2} . . . Δₜ_{ₖ}^{j,i} is calculated. Specifically, the weight of Δ̅ₜ̅_̅{̅ₖ̅}̅^̅{̅j̅}̅ is found with the number of previous participants nₜ_{ₖ}^{j}, whereas the remaining weights, i.e., those of the improvement-values Δₜ_{ₖ}^{j,1}, Δ_{t,k}^{j,2} . . . Δₜ_{ₖ}^{j,i} are uniformly set to 1

Plugging in the update mechanism of nₜ_{ₖ₊₁}^{j} as seen previously, one thus obtains the simplified evolution expression of the average improvement-value Δ̅ₜ̅_̅{̅ₖ̅₊̅₁̅}̅^̅{̅j̅}̅ in the second line

Specifically, the quick test method is to test 20 quick test items in the first two minutes and the last two minutes of the same lesson, or the therapist judges the scores.

A. Progress Value

The post test score of the same level I indicator subtracts the pre-test score to obtain the improvement value of the indicator Δ, Here, the greater the progress value, the greater the improvement of this ability in this class. The maximum progress value is 4 points, However, there are two cases where the progress value is 0:1. This ability is not involved in this lesson, and it cannot improve children's ability in this aspect; 2. The child has reached the ceiling of development, with the highest scores in the first and second times, or cannot see great improvement in a short time.

B. Average

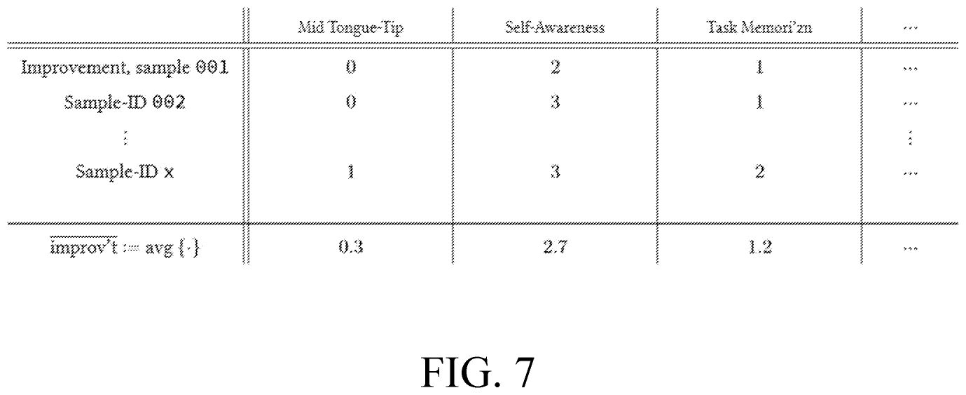

Collect the pre-test and post test data of several children in this class. After averaging the progress value, the curriculum can be evaluated in reverse, and the contribution value of this class to different indicators of social function can be obtained, as shown in FIG. 7.

C. Course Sequencing

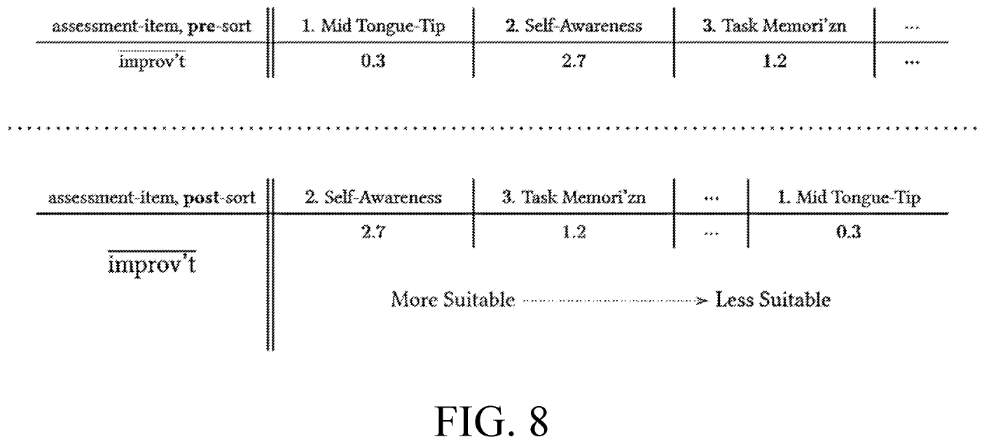

Each class can use the above methods to get the average progress value. The courses can be sorted according to the value of the average progress value, or the functional attributes of a class can be sorted according to the contribution value, as shown in FIG. 8.

D. Establish a Course Library

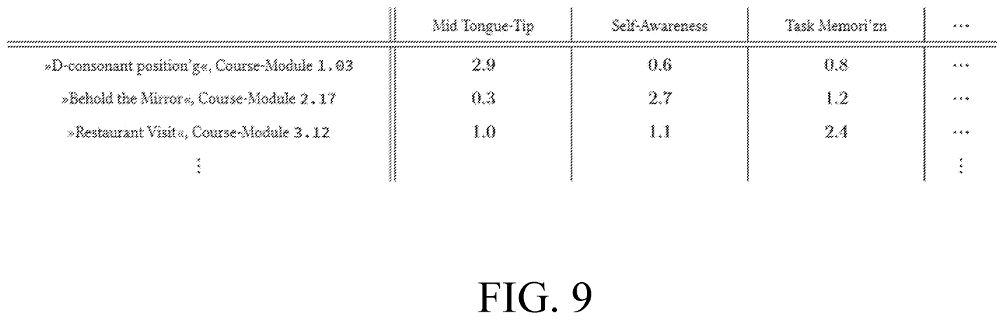

In the course of designing the course, if it is possible to hope that this lesson mainly improves the tip of the tongue in speech articulation, but because there are also words and sentences to learn, as well as teacher-student interaction in the teaching process, it may also improve in other functional areas, such as greetings. Then we can take the contributions of various fields of courses as the basis of course classification according, to the previous order. FIG. 9 shows the contribution values of different courses in various functional indicators.

E. Push Courses

This is pushed based on the potential value in the function evaluation. For example, when the child's self-consciousness potential value in social ability is the highest, he can choose to look in the mirror when choosing a course for the child; However, when the child lacks self-awareness and working memory, he or she can give priority to going to the restaurant.

When the number of children in class increases, the new progress value will be input into the curriculum library for data update. At the same time, curriculum design can also be improved according to children's progress value in this process.

Level 0 indicators in the quick test method: speech articulation, social ability, and executive function; 20 level 1 indicator are consistent with those in the functional evaluation. The reasons are as follows: 1. The curriculum is designed according to the three major functions and their first-level indicators; 2. The results of the functional evaluation can be compared with the results of each level of course evaluation.

The invention also provides a system for realizing the above curriculum effect evaluation and recommendation method, which comprises a data entry module, a database module, a machine learning module and a prediction module; Among them,

Data entry module: including front-end web page and WeChat applet, which is responsible for entering the scores of two quick tests for autistic children before and after each class;

Database module: it is responsible for storing and screening the scores of two quick tests of autistic children before and after each class; The filtering is to filter the data according to the required model and model characteristics;

Machine learning module: use the iterative algorithm in cybernetics to learn and establish the effect evaluation and course recommendation model of the autistic children's rehabilitation course, so as to obtain the average progress value of the autistic children in each course;

Output module: It is responsible for recommending regular courses for children by combining the quick test score evaluation results with the calculated average progress value of each course.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method to informationize the development of autistic children and predicting their future careers, comprising:
Step a: collecting the assessment data C and occupational lioness value s of autistic children required by the occupational prediction model;
Step b: constructing an occupational prediction model, assessment data C and occupational fitness value s collected from Step a are used to train the occupational prediction model for obtaining a completed model for occupational prediction
Step c: collecting the evaluation data C of the children to be predicted, and use the occupational prediction model trained in step b to evaluate the occupational fitness value s of the children to be predicted, to obtain the suitable occupation for the children to be predicted.

2. The method according to claim 1, wherein the assessment data C is obtained through the assessment comprising a background constant value C^{c} and an autistic children's ability measurement value C^{v};
the background constant value C^{c} comprises developmental information and autism diagnosis information;
the autistic children's ability measurement value C^{v} comprises assessment scores of consonant articulation, social interaction, and executive function brief2 scale scores for children with autism;
the occupational fitness value s is obtained through the evaluation of children who have corresponding suitable occupational positions.

3. The method according to claim 2, wherein the background constant value C^{c} of autistic children comprises developmental information and autism diagnosis information, represents the information related to children's initial ability and education and rehabilitation environment;
the developmental information comprises basic information about the child and the educational rehabilitation history of autistic children;
the autism diagnosis information is specifically expressed by selecting existing scores of commonly used scales for autism, is includes the scores of the autism screening scale score, autism diagnosis scale score, and other psychological assessment scale scores;
the autism screening scale is a modified infant autism scale M-CHAT (16-30 months);
the autism diagnosis scales comprise Children Autism Rating Scale CARS, Autism Behavior Scale ABC, Autism Diagnosis Observation Scale ADOS-2;
the other psychological assessment scales comprise Wechsler Intelligence Scale, Psychological Education Assessment Scale PEP-3, Picture Vocabulary Test (Chinese version) PPVT-R, Language Behavior Milestone Assessment and Placement Plan VB-MAPP Obstacle Assessment;
the autistic children's ability measurement value C^{v} can indicate the specific ability level of autistic children in speech articulation, social ability and executive function fields, and the authoritative scale score in the field is selected for measurement;
the autistic children's ability measurement value C^{v} comprises consonant articulation assessment scores, social interaction assessment scores, and executive function brief2 scale scores.

4. The method according to claim 3, wherein the basic information of the child comprises the child's name, gender, date of birth, age of diagnosis, concurrent diseases, family income, main caregivers, and education of the caregivers;
the educational rehabilitation process of autistic children refers to the age of rehabilitation, the number of rehabilitation process changes, satisfaction with rehabilitation effect, rehabilitation frequency, annual rehabilitation expenditure, and types of rehabilitation courses before and after enrollment in the group;
the assessment information of the consonant articulation of autistic children comprises the assessment results of bilabial/labiodental, dentolabial, alveolar/alveolopalatal, postalveolar/retroflex, velar, the four tones;
the social interaction assessment information is assessed using the Children's Social Positioning Map;
the executive function brief2 scale selects five categories that are confirmed to be effective for autistic children by clinical tests as evaluation indicators, namely: starting ability, planning and organization ability, conversion ability, working memory ability, and self-monitoring ability.

5. The method according to claim 1, wherein the occupational fitness value s refers to the fitness of autistic children for a certain occupation, which is evaluated by autistic children who have obtained corresponding occupational positions;
the assessment tool is an original occupational category assessment form for autistic patients, including an assessment category and a questionnaire;
the occupational category assessment form has a total score of 240 points, of which the assessment category contains cognitive development, movement, perceptual characteristics and social development with a total score of 180 points; the questionnaire of the occupational category assessment form contains movement, perceptual characteristics and social development with a total score of 60 points.

6. The method according to claim 2, wherein the assessment data C as described in Step b is defined as:
C:=[C^{c} C^{d} C^{a} C^{s} C^{f}]^{T}
∈ [symbol] ⁵⁺²⁰≡ [symbol] ²⁵
wherein C^{c} represents an autistic individual's essential information, C^{d} represents autistic diagnostic information, C^{a} represents autistic consonants articulation ability, C^{s} represents autistic social communication skills, and C^{f} represents functional execution on the brief2 scale, the super-script [−]^{T} denotes the matrix/vector transpose;
wherein the background constant values C^{c}=C^{c}+C^{d}; the autistic children's ability measurement value C^{v}=C^{a}+C^{s}+C^{f}.

7. The method according, to claim 2, wherein in step b, the occupational prediction model uses a linear regression model,
techniques from machine-learning with the linear regression model are utilized to associate the assessment data C and the occupational fitness value s;
the loss-function of the linear regression model is calculated as the sum of the square 2-norm of prediction-errors on the data-pairs (xᵢ, yᵢ)
$$\begin{matrix}\text{?} := {\sum }_{i} \text{?} \\ {\sum }_{i} \text{?}\end{matrix} .$$
$$\text{?} \text{indicates text missing or illegible when filed}$$

8. A system to informationize the development of autistic children and predicting their future careers, comprising: a data input module, a database module, a machine learning module, a prediction module, and an output module;
wherein
the data input module is used for entering the developmental information and the diagnosis information of autistic children, the assessment score of the consonant articulation of autistic children, the social interaction assessment score, and the executive function brief2 scale score;
the database module is used for storing and screening the input developmental information and diagnosis information of autistic children, as well as the assessment scores of autistic children's consonant articulation, social interaction and executive function brief2 scale scores;
the machine learning module is used for learning and establishing the occupational prediction model of autistic children using the machine learning algorithm library in Python, and obtaining the weight value of various autistic children's characteristics in this model for the future occupation of autistic children;
the prediction module is used for substituting the basic information of autistic children, diagnosis result information, evaluation information of consonant articulation of autistic children, social communication orientation map, and executive function brief2 scale score into the established and calculated model for prediction;
the output module is used to output the suitable occupation for autistic children in the future.

9. A method for assessing the effectiveness of a rehabilitation program for autistic children and recommending the program, comprising:
Step I: obtaining the test results k1 and k2 of autistic children before and after each class;
Step II: calculating the difference between the test results of each autistic child's before and after each class, the progress value Δ=k2−k1;
Step III: whenever new participants participate in a course j at the time tₖ, the number of the new participants is i, the number of whole participants who have participated in the course is updated to nₜ_{ₖ₊₁}^{j}, nₜ_{ₖ₊₁}^{j} is calculated as the sum of the number of new participants i and the old participants nₜ_{ₖ}^{j} who have participated in the course [symbol]
Step IV: the historical average progress value Δ̅ₜ̅_̅{̅ₖ̅}̅^̅{̅j̅}̅ of the course before the new participants participated in the course is weighted with the progress value Δₜ_{ₖ}^{j,1}, Δₜ_{ₖ}^{j,2}, . . . , Δₜ_{ₖ}^{j,i} of the total i new participants participating in the course j obtained in Step II; the weight of the historical average progress value is the number of students nₜ_{ₖ}^{j}, who participated in the course previously, and the weight of the progress value of each new participant is 1;
Step V: according to the progress value obtained in step IV, evaluating and ranking the contribution value of the course to different indicators in social function;
Step VI: according to the ranking of different indicators corresponding to different courses, recommending courses suitable for children.
